(19) United States
(12) Patent Application Publication
(10) Pub. No.: US 2008/0016335 A1
(43) Pub. Date: Jan. 17, 2008

(54) Attribute Certificate Verification Method and System

(76) Inventors: Aya Takahashi, Sagamihara (JP); Hisao Sakazaki, Chigasaki (JP); Seiichi Susaki, Yokohama (JP); Kazuko Hamaguchi, Yokohama (JP); Katsuyuki Umezawa, Machida (JP); Ken Kobayashi, Machida (JP); Kazuyoshi Hoshino, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/762,412

(22) Filed: Jun. 13, 2007

(30) Foreign Application Priority Data
Jun. 13, 2006 (JP) 2006-163575
Mar. 6, 2007 (JP) 2007-055295

(51) Int. Cl. H04L 9/32

(52) U.S. Cl. 713/156

(57) ABSTRACT

Upon issuance of an attribute certificate, an attribute authority apparatus makes a determination policy available. The determination policy includes information designating at least one item to be checked by a service provider apparatus for determination to be made to verify the attribute certificate, and a criterion for the determination. The determination policy may be recorded in the attribute certificate, or released to public, or made available by issuing a determination policy certificate released to public. Information for obtaining the determination policy certificate may be recorded in or outside the attribute certificate and furnished to the service provider apparatus. In order to verify an attribute certificate transmitted from a user terminal, a service provider apparatus obtains the determination policy, and determines whether data in the at least one item designated in the determination policy fulfill the criterion recorded in the determination policy.

### CROSS-REFERENCE TO RELATED APPLICATIONS

This application claims the foreign priority benefit under Title 35, United States Code, §119 (a)-(d), of Japanese Patent Application Nos. 2006-163575 and 2007-055295, filed on Jun. 13, 2006 and Mar. 6, 2007 respectively, in the Japan Patent Office, the disclosure of which is herein incorporated by reference in its entirety.

### BACKGROUND OF THE INVENTION

Apparatuses and methods consistent with the present invention relate to application of attribute certificates. In particular, the present invention relates to an attribute certificate verification method, an attribute authority apparatus, a service provider apparatus, and an attribute certificate verification system.

To verify the authenticity of a person who uses a terminal to access a server providing a specific service on a network, a method of verification using a public key certificate is in use. On the other hand, to verify the qualification and/or power of the person who uses the terminal, a method of verification using an attribute certificate is in use. The public key certificate is a piece of data having a value of a public key and a name of a private key holder (a person who holds a private key corresponding to the public key) or an identification number of a terminal used by the private key holder associated with each other. The authenticity of the public key certificate is ensured by an electronic signature of a certificate authority provided in a certificate authority apparatus. The attribute certificate is a piece of data having information on linkage with a public key certificate, and attributes of a holder of the public key certificate. The authenticity of the attribute certificate is ensured by an electronic signature of an attribute authority provided in an attribute authority apparatus.

The syntaxes for representing the information on linkage with a public key certificate, in the holder field of an attribute certificate, as specified in the standard protocol RFC 3281 for an attribute certificate profile, may include one or more of the following options: (1) baseCertificateID used to record a serial number and an issuer of the public key certificate; (2) entityName used to record a value recorded in the subject field of the public key certificate; and (3) objectDigestInfo used to record a hash of a specific object. Thus, for validation of the linkage with a public key certificate, it is necessary to check whether the value (content) in the holder field of the attribute certificate is identical to the value (content) in the public key certificate as determined in accordance with the corresponding syntax option (1), (2) or (3). For details, see S. Farrell, R. Housley, “An Internet Attribute Certificate Profile for Authorization” RFC 3281, April, 2002, at http://www.ietf.org/rfc/rfc3281.txt.

Among the above options, the syntax in option (1) or option (3) using a hash of a public key certificate (e.g., a hash value of public key certificate 70-i of FIG. 6) associates attribute certificates with public key certificates in a one-to-one relationship. Therefore, one attribute certificate cannot be associated with more than one public key certificate. In contrast, the syntax in option (2) or option (3) using a hash of a public key contained in a public key certificate (e.g., a hash value of public key information 75 of FIG. 6) does not require a one-to-one relationship, and it is thus possible to maintain the linkage between a public key certificate and an attribute certificate even after the public key certificate is updated. However, when option (2) is adopted, the subject field of one public key certificate may happen to have a value identical to that of another public key certificate, with the result that an attribute certificate could possibly be associated with a wrong public key certificate with which no linkage should be established.

With these circumstances in view, methods for creating a public key certificate, for creating an attribute certificate, and for verifying a linkage between public key and attribute certificates have been proposed, for example, in JP 2004-282636 A. In the method disclosed in JP 2004-282636 A, when an attribute certificate is issued, a hash value of a public key certificate of a holder of the attribute certificate is recorded in the attribute certificate. When the public key certificate is updated, a hash value of the pre-update public key certificate is recorded in the updated public key certificate. When the linkage between a public key certificate and an attribute certificate is validated, the hush values recorded in the public key certificate and the attribute certificate are compared. Accordingly, the methods proposed in JP 2004-282636 A can properly determine whether the linkage should be validated between the public key certificate and the attribute certificate.

In the above method, however, a hash value of a pre-update public key certificate should be recorded in a new public key certificate, and thus a modification in the format of the public key certificates is a prerequisite. Nevertheless, such prerequisite modification in the format of the public key certificates would be difficult because the public key certificates have already been widely used as compared with the attribute certificates.

It would be desirable, as described above, that once an attribute certificate is issued to individual persons, the same attribute certificate be used continuously even after a public key certificate associated therewith is updated. Besides, there is a general demand for using a single attribute certificate associated with a plurality of public key certificates. For example, the attributes a company possesses (e.g., having an alliance formed with another company, holding membership in a corporate association, being affiliated with a group of companies) are those possessed commonly among all the staffs of the company, and it would thus be desirable that a single attribute certificate be used by all the staffs of the company. However, the existing methods for verifying a linkage between a public key certificate and an attribute certificate would require that information recorded in the holder field of the attribute certificate and information recorded in the public key certificate be precisely identical to each other; thus, it is not possible to use a single attribute certificate associated with a plurality of public key certificates having different serial numbers, subjects, etc. Consequently, the attribute authority would have to issue a plurality of attribute certificates the number of which corresponds to that of the public key certificates even though the attribute certificates contain the same attribute information, so that the clerical works for issuance would disadvantageously become burdensome. Furthermore, the administrative works for managing information on issued attribute certificates and expiration/invalidation statuses thereof would also become burdensome.

The present invention has been made in an attempt to eliminate or overcome the above-described disadvantages. Exemplary embodiments of the present invention relate to a method and system for verifying an attribute certificate in a variety of applications of the attribute certificate, and an attribute authority apparatus and a service provider apparatus for use therewith.

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

### SUMMARY OF THE INVENTION

It is an aspect of the present invention to provide a method by which a single attribute certificate associated with a plurality of public key certificates can be utilized. To be more specific, in an exemplary embodiment, when an attribute authority issues an attribute certificate of a user, an attribute authority apparatus thereof records, for example in a holder field of the attribute certificate with an entityName option applied thereto, information recorded in a subject field of a public key certificate of the user. The attribute authority apparatus also records, in an extension field of the attribute certificate, a determination policy which comprises information designating at least one item to be checked by a service provider apparatus for determination to be made to verify the attribute certificate (a linkage between the attribute certificate and the public key certificate), and a criterion for the determination. When the service provider apparatus verifies an attribute certificate transmitted from a user terminal of the user, the service provider apparatus obtains the determination policy recorded in the attribute certificate, and determines whether data in each of the at least one item designated in the determination policy fulfill the criterion recorded in the determination policy to verify the attribute certificate. In this embodiment, the information recorded in the holder field of the attribute certificate includes the at least one item designated in the determination policy, and the determination may be made by comparing the information recorded in the holder field of the attribute certificate with information recorded in the subject field of the public key certificate.

The attribute authority apparatus may release a determination policy to public, and record, in an extension field of the attribute certificate, location information on a location at which the determination policy is released to public. In this embodiment, when the service provider apparatus verifies an attribute certificate transmitted from a user terminal of the user, the service provider apparatus obtains the location information recorded in the attribute certificate, obtains the determination policy from the location designated by the location information, and determines whether data in each of the at least one item designated in the determination policy fulfill the criterion recorded in the determination policy to verify the attribute certificate.

The present invention also proposes a method by which a single attribute certificate associated with a plurality of public key certificates can be utilized without the need for modifying a format of the attribute certificate or the like. To be more specific, in another exemplary embodiment, when an attribute authority issues an attribute certificate of a user, an attribute authority apparatus thereof records, for example in a holder field of the attribute certificate with an entityName option applied thereto, information recorded in a subject field of a public key certificate of the user. The attribute authority also issues (and thus the attribute authority apparatus thereof transmits to a user terminal of the user) a determination policy certificate in which is recorded a determination policy comprising information designating at least one item to be checked by the service provider apparatus for determination to be made to verify the attribute certificate (a linkage between the attribute certificate and the public key certificate), and a criterion for the determination. The attribute authority apparatus also releases validation information (or invalidation information) which is to be used by the service provider apparatus to check the validity of the determination policy certificate, to public. When the user makes a request for a service to the service provider apparatus, the user terminal transmits the determination policy certificate together with the attribute certificate to the service provider apparatus. When the service provider apparatus verifies the attribute certificate transmitted from the user terminal, the service provider apparatus obtains the invalidation or validation information to ascertain the validity of the determination policy certificate, and proceeds to determine whether data in each of the at least one item designated in the determination policy recorded in the determination policy certificate fulfill the criterion recorded in the determination policy certificate to verify the attribute certificate.

In yet another exemplary embodiment, the attribute authority apparatus may release a latest determination policy certificate to public, and issues, and transmits to the user terminal, determination policy certificate retrieval information including location information on a location at which the determination policy certificate is released. In this embodiment, when the user makes a request to the service provider apparatus for a service, the user terminal transmits the determination policy certificate retrieval information together with the attribute certificate to the service provider apparatus. When the service provider apparatus verifies the attribute certificate transmitted from the user terminal, the service provider apparatus obtains the location information on the location at which the latest determination policy certificate is released, which location information is included in the determination policy certificate retrieval information. The service provider apparatus then obtains the determination policy certificate from the location designated by the location information, and determines whether data in each of the at least one item designated in the determination policy certificate fulfill the criterion recorded in the determination policy certificate to verify the attribute certificate.

### BRIEF DESCRIPTION OF THE DRAWINGS

The aspects, other advantages and further features of the present invention will become more apparent by describing in detail illustrative, non-limiting embodiments thereof with reference to the accompanying drawings, in which:

FIG. 1 is a schematic diagram showing an example of a system configuration to which the present invention is applicable;

FIG. 2 is a schematic diagram showing a hardware configuration of each apparatus depicted in FIG. 1;

FIG. 3A is a schematic diagram showing a software configuration of a certificate authority apparatus according to an exemplary embodiment;

FIG. 3B is a schematic diagram showing a software configuration of an attribute authority apparatus according to an exemplary embodiment;

FIG. 4 is a schematic diagram showing a software configuration of a user terminal according to an exemplary embodiment;

FIG. 5 is a schematic diagram showing a software configuration of a service provider apparatus according to an exemplary embodiment;

FIG. 6 is a schematic diagram showing data specifications of a public key certificate of a user terminal according to an exemplary embodiment;

FIG. 7 is a schematic diagram showing data specifications of an attribute certificate of a user terminal according to an exemplary embodiment;

FIG. 8 is a flowchart showing a process for allowing a user terminal to receive a service from a service provider apparatus according to an exemplary embodiment;

FIG. 9 is a flowchart showing a detailed process, to be executed by a service provider apparatus, for verifying an attribute certificate according to an exemplary embodiment;

FIG. 10 is a schematic diagram showing data specifications of an attribute certificate of a user terminal according to another exemplary embodiment;

FIG. 11 is a schematic diagram showing a software configuration of an attribute authority apparatus according to another exemplary embodiment;

FIG. 12 is a schematic diagram showing data specifications of an attribute certificate of a user terminal according to another exemplary embodiment;

FIG. 13 is a schematic diagram showing data specifications of a determination policy certificate according to an exemplary embodiment;

FIG. 14 is a schematic diagram showing data specifications of invalidation information of the determination policy certificate according to an exemplary embodiment;

FIG. 15 is a flowchart showing a process for allowing a user terminal to receive a service from a service provider apparatus according to another exemplary embodiment;

FIG. 16 is a flowchart showing a detailed process, to be executed by a service provider apparatus, for verifying an attribute certificate according to another exemplary embodiment;

FIG. 17 is a schematic diagram showing data specifications of determination policy certificate retrieval information according to an exemplary embodiment;

FIG. 18 is a schematic diagram showing a software configuration of an attribute authority apparatus according to yet another exemplary embodiment;

FIG. 19 a flowchart showing a process for allowing a user terminal to receive a service from a service provider apparatus according to yet another exemplary embodiment; and

FIG. 20 is a flowchart showing a detailed process, to be executed by a service provider apparatus, for verifying an attribute certificate according to yet another exemplary embodiment.

### DETAILED DESCRIPTION OF THE EXEMPLARY EMBODIMENTS

Exemplary non-limiting embodiments of the present invention will be described hereafter with reference to the drawings.

### First Embodiment

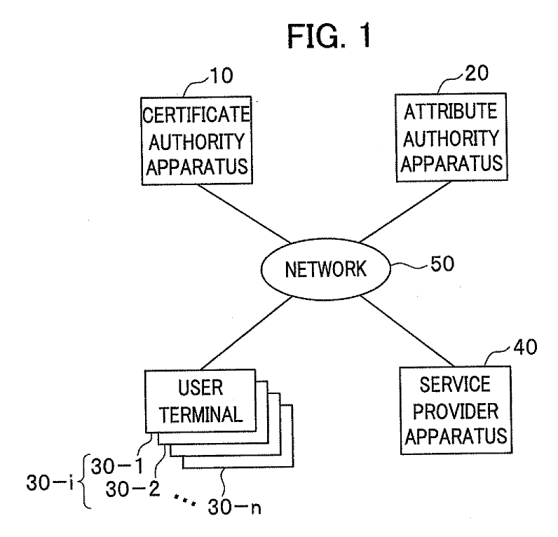

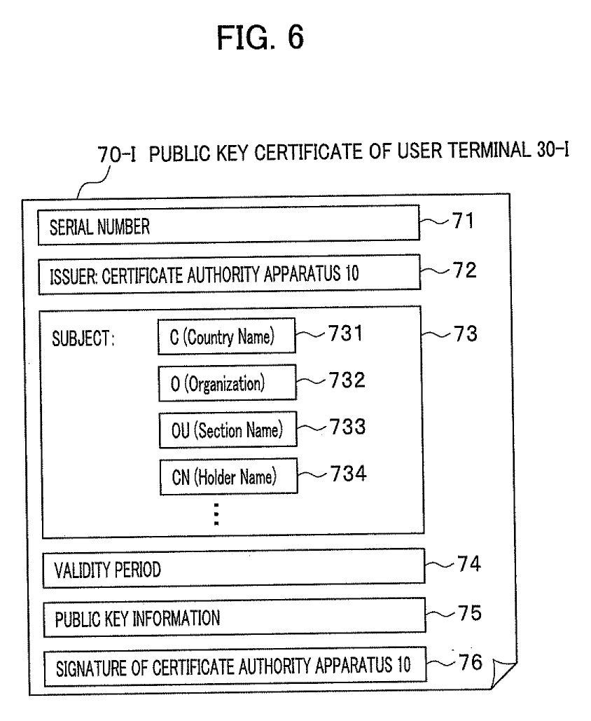

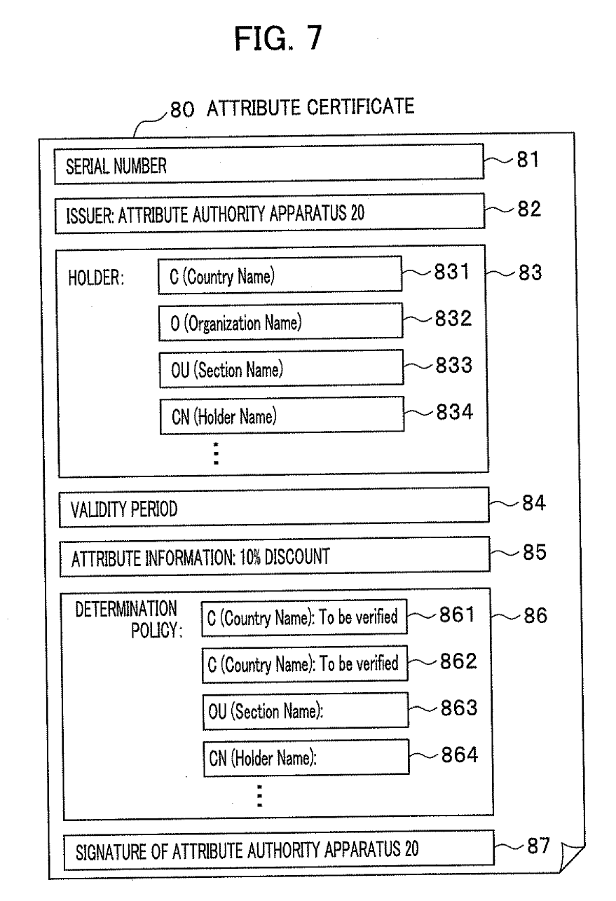

Referring to FIG. 1, an example of a system configuration to which the present invention is applicable is shown. There are provided a certificate authority apparatus 10 for issuing a public key certificate 70-i (see FIG. 6) to each user, an attribute authority apparatus 20 for issuing an attribute certificate 80 (see FIG. 7) common to the users, user terminals 30-i (30-1, . . . , 30-n) of the users who receive services, and a service provider apparatus 40 which provides services and has an authorization capability based on attribute certification, all of which are coupled through a network 50, such as the Internet and a mobile network. Assume in this embodiment that the user terminal 30-1 is a representative of the user terminals 30-1, . . . , 30-n of staffs (users) in a company or other entity, and the attribute certificate 80, which will be described later, is issued with a linkage with the public key certificates 70-i of users who uses the user terminals 30-i.

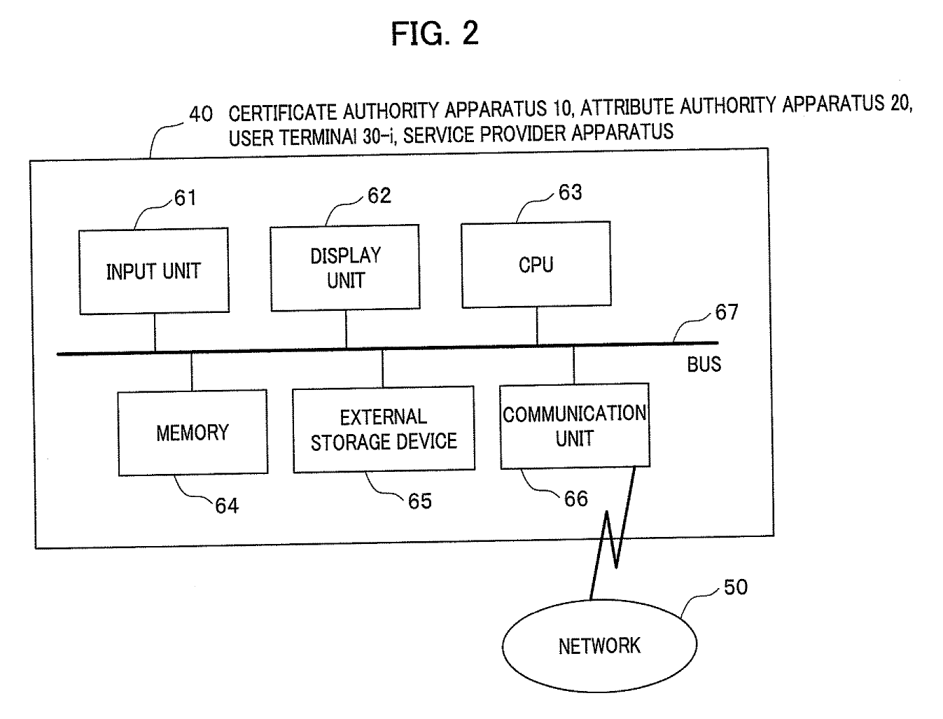

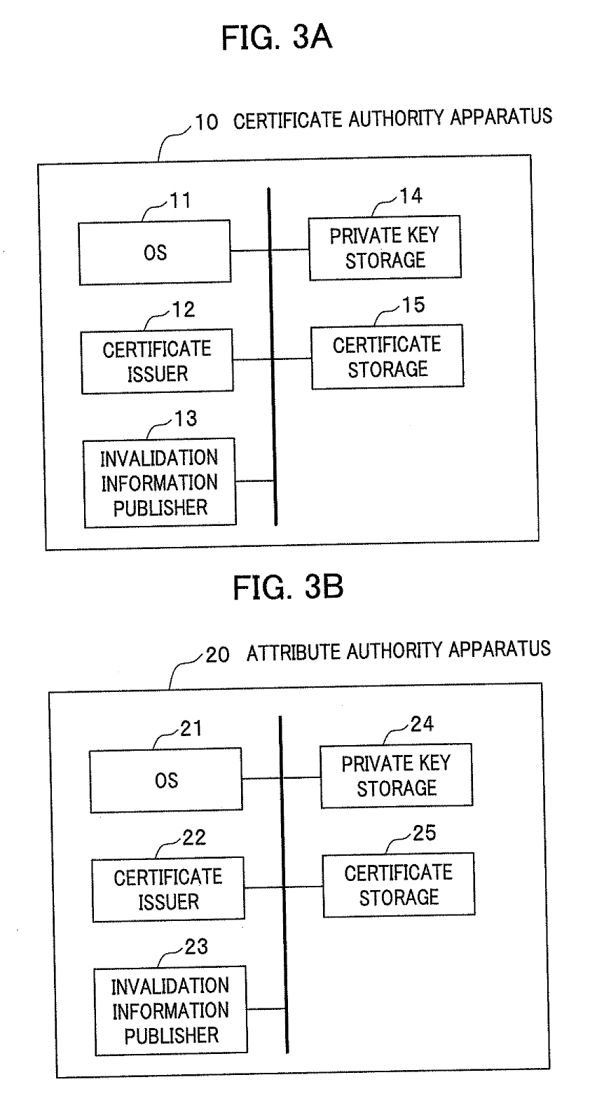

Turning to FIG. 2, a hardware configuration of each apparatus enumerated above with reference to FIG. 1 is shown. Each of the certificate authority apparatus 10, the attribute certificate apparatus 20, the user terminals 30-i (i=1, . . . , n, in FIG. 2), and the service provider apparatus 40 (hereinafter referred generally to as each apparatus 10-40) includes an input unit 61, a display unit 62, a central processing unit or CPU (controller) 63, a memory 64, an external storage device 65, and a communication unit 66 which are coupled with each other through a bus 67 or the like. The input unit 61 is a device used by an operator (user) of each apparatus 10-40 to input data or commands, and includes a keyboard, a mouse or the like. The display unit 62 is a device used to show messages or the like to the operator (user) of each apparatus 10-40, and includes a cathode ray tube or CRT, a liquid crystal display or LCD, or the like. The CPU (controller) 63 is configured to execute programs stored in the memory 64 or the external storage device 65 to centrally manage each element (e.g., input unit 61, communication unit 66) of each apparatus 10-40 and perform various operations. The memory 64 is a device for temporarily loading or storing a program (software module) as shown in FIGS. 3-5 and/or data required for processing. The external storage device 65 is a device used to semipermanently store the programs and data used for each apparatus 10-40, and includes a hard disk drive or the like. The communication unit 66 is an interface for exchange of data through the network 50 among apparatuses 10-40 shown in FIG. 1. The bus 67 is a transmission line through which data is to be transferred among the elements (e.g., input unit 61, . . . , communication unit 66), though any transmission line other than the bus may be used.

FIGS. 3A and 3B schematically show software configurations of the certificate authority apparatus 10 and the attribute authority apparatus 20, respectively.

The certificate authority apparatus 10 includes an operating system or OS 11, a certificate issuer 12, an invalidation information publisher 13, a private key storage 14 for storing private keys held by the certificate authority apparatus 10, and a certificate storage 15 for storing public key certificates of the certificate authority apparatus 10 corresponding to the private keys. The certificate issuer 12 of the certificate authority apparatus 10 is configured to issue, and transmit to a user terminal 30-i, a public key certificate 70-i (see FIG. 6) which includes information created by associating an identifier of the user terminal 30-i with a public key of the user terminal 30-i and affixing an electronic signature thereto using a private key of the certificate authority apparatus 10.

The attribute authority apparatus 20, like the certificate authority apparatus 10, includes an operating system or OS 21, a certificate issuer 22, an invalidation information publisher 23, a private key storage 24 for storing private keys held by the attribute authority apparatus 20, and a certificate storage 25 for storing public key certificates of the attribute authority apparatus 20 corresponding to the private keys.

The certificate issuer 22 of the attribute authority apparatus 20 is configured to issue, and transmit to a user terminal 30-i, an attribute certificate 80 (see FIG. 7) which includes information created by associating information on a public key certificate 70-i of the user terminal 30-i with attribute values of the user and affixing an electronic signature thereto using a private key of the attribute authority apparatus 20. In the present embodiment, the syntax for representing information on linkage with the public key certificate 70-i of the user terminal 30-i in the holder field of the attribute certificate 80 to be issued by the certificate issuer 22 of the attribute authority apparatus 20 may be the option using entityName to record a value recorded in the subject field of the public key certificate 70-i of the user terminal 30-i. Furthermore, items, such as ‘O (Organization Name)’, ‘OU (Section Name)’, to be checked by the service provider apparatus 40 which is presented with the attribute certificate 80 and the public key certificate 70-i for determination to be made to verify a linkage between the attribute certificate 80 and the public key certificate 70-i, and criteria for the determination, such as ‘To be verified’, ‘Not to be verified’, etc. are recorded as a determination policy 86 (see FIG. 7) in an extension field of the attribute certificate 80. The extension field for the determination policy 86 will hereinafter be referred to as determination policy field using the same reference numeral 86 for convenience’ sake.

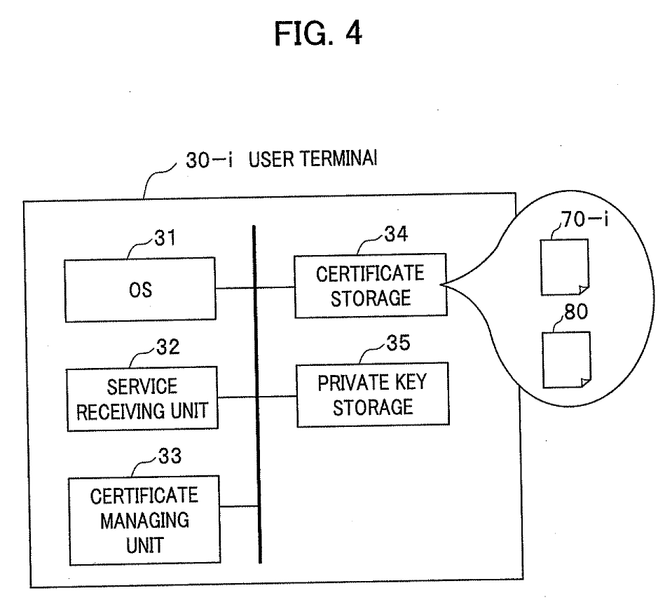

FIG. 4 shows a software configuration of each user terminal 30-i. The user terminal 30-i (i=1, . . . , n, in FIG. 4) includes an operating system or OS 31, a service receiving unit 32, a certificate managing unit 33, a certificate storage 34 for storing public key certificates 70-i (i=1, . . . , n, in FIG. 4) and an attribute certificate 80 of the user terminals 30-i (i=1, . . . , n, in FIG. 4), and a private key storage 35 for storing private keys of the user terminals 30-i. The service receiving unit 32 corresponds to a web browser or the like used to receive a service on the network 50 from the service provider apparatus 40. The certificate managing unit 33 is configured to obtain a public key certificate 70-i or an attribute certificate 80 of the user terminal 30-i from the certificate storage 34, to obtain a private key from the private key storage 35, and to affix a signature to the certificate 70-i or 80 using the obtained private key.

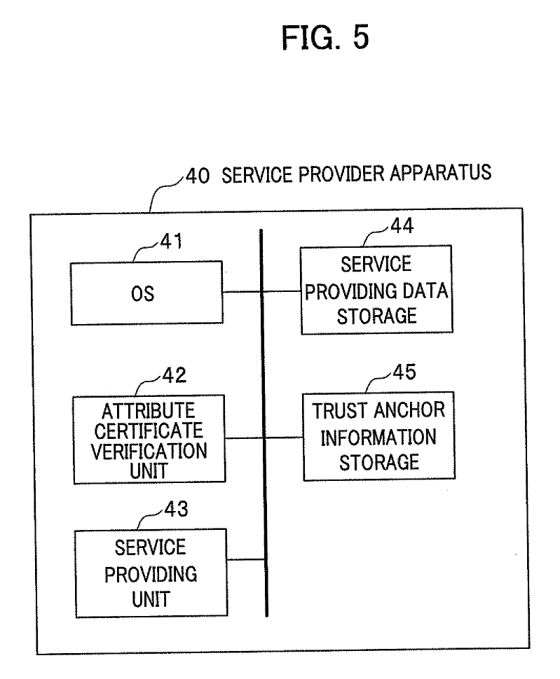

FIG. 5 shows a software configuration of a service provider apparatus 40. The service provider apparatus 40 includes an operating system or OS 41, an attribute certificate verification unit 42, a service providing unit 43, a service providing data storage 44, and a trust anchor information storage 45 for storing trust anchor information of the service provider apparatus 40. The attribute certificate verification unit 42 is configured to verify the authenticity of a user terminal 30-i which presents the attribute certificate 80, the authenticity of the contents of the attribute certificate 80, and the like. The service providing unit 43 corresponds to a web server or the like which the service provider apparatus 40 uses to provide a service on the network 50. The service providing data storage 44 provides a storage area for storing HTML files or the like used in the service providing unit 43.

FIG. 6 shows data specifications of a public key certificate of a user terminal issued by the certificate authority according to an exemplary embodiment of the present invention. The public key certificate 70-i has fields of a serial number 71 of the public key certificate 70-i, an issuer 72 of the public key certificate 70-i, a subject 73 of the public key certificate 70-i, a validity period 74 of the public key certificate 70-i, public key information 75 and others as specified in the standard protocol RFC 3280 for a private key certificate profile. The public key certificate 70-i consists of data with an electronic signature 76 affixed thereto by means of a private key of the certificate authority apparatus 10. The subject field 73 includes C (Country Name) 731, O (Organization Name) 732, OU (Section Name) 733, CN (Holder Name) 734, etc. In this embodiment, the public key certificate 70-1 of the user terminal 30-1 has ‘JP’ (Japan) recorded in item 731, and ‘Company A’ recorded in item 732, but no data recorded in items including those denoted by 733, 734. The public key certificate 70-i of the user terminal 30-i (i=2, . . . , n) has ‘JP’ (Japan) recorded in item 731, and ‘Company A’ recorded in item 732, ‘Section a’ recorded in item 733, and ‘user i’ recorded in item 734. It is assumed that the attribute certificate 80 which will be described later is associated with this public key certificate 70-1 when it is issued.

FIG. 7 shows data specifications of an attribute certificate issued by the attribute authority (apparatus) according to an exemplary embodiment of the present invention. The attribute certificate 80 has fields of a serial number 81 of the attribute certificate 80, an issuer 82 of the attribute certificate 80, a holder 83 of the attribute certificate 80, a validity period 84 of the attribute certificate 80, attribute information 85, and others as specified in the standard protocol RFC 3281 for an attribute certificate profile, plus a determination policy 86 recorded in an extension field. The attribute certificate 80 consists of data with an electronic signature 87 affixed thereto by means of a private key of the attribute authority apparatus 20. In items including those referenced 831-834 of the holder field 83, to which an entityName option is applied, is recorded information recorded in the subject field 73 of the public key certificate 70-1 with which the attribute certificate 80 is associated when it is issued. The determination policy field 86 includes information which designates items to be checked for determination to be made to verify a linkage with the public key certificate 70-i when the attribute certificate 80 is to be verified, and a criterion for determination of each item (e.g., item 861, . . . , 864). In this embodiment, ‘C (Country Name)’ as an item to be checked and ‘To be verified’ as a corresponding determination criterion are designated in item 861, and ‘O (Organization Name)’ as an item to be checked and ‘To be verified’ as a corresponding determination criterion are designated in item 862, such that all the staffs of Company A can use this attribute certificate 80 associated with their own public key certificates 70-i. It is appreciated that items 863, 864, etc. are not used since no corresponding determination criteria are specified therefore. Furthermore, the attribute information 85 contains information on the status of the Company A as an eligible entitled to a 10% discount service. The attribute certificate 80, which has been associated with the public key certificate 70-1 and issued to the user terminal 30-1 by the certificate issuer 22 of the attribute authority apparatus 20 in advance, is stored in the certificate storage 34 of the user terminal 30-1, . . . , 30-n.

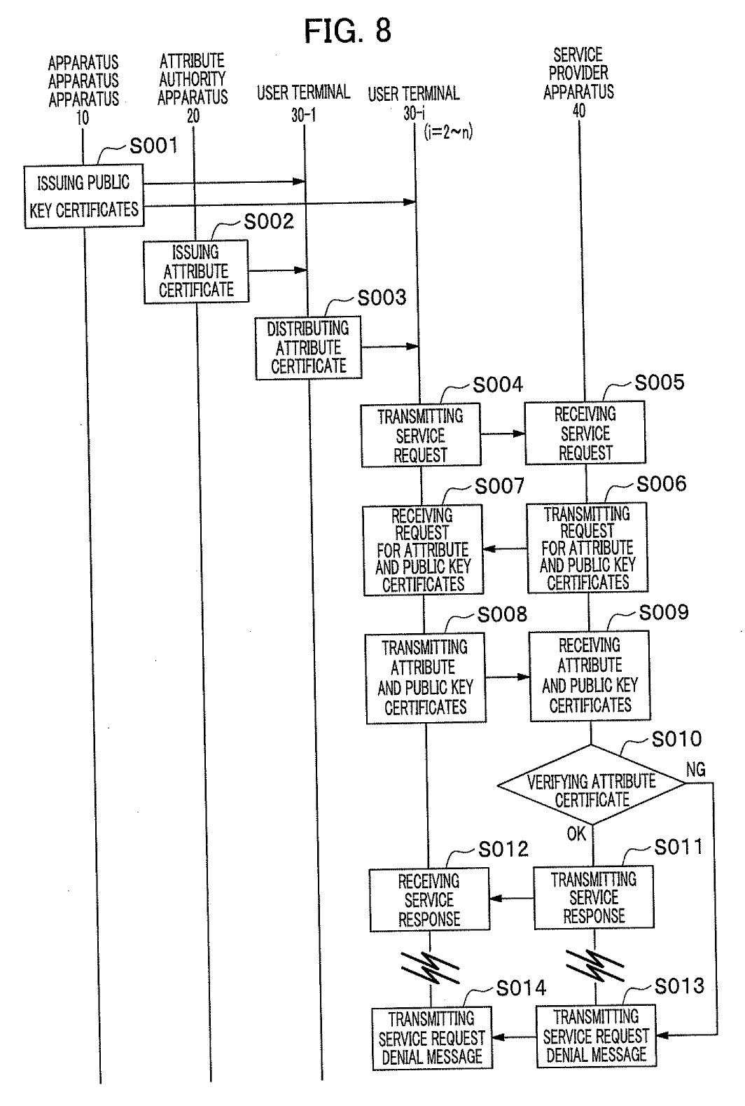

FIG. 8 is a flowchart showing a process for allowing a user terminal to receive a service from a service provider apparatus according to an exemplary embodiment. The certificate authority apparatus 10 has issued, in advance, public key certificates 70-1, . . . , 70-i (i=2, . . . , n in FIG. 8) to user terminals 30-1, . . . , 30-i (i=2, . . . , n in FIG. 8) (step S001). The public key certificates 70-1, . . . , 70-i, thus issued, are stored in the certificate storage 34. The attribute authority apparatus 20 has associated, in advance, the attribute certificate 80 with the public key certificate 70-1, and has issued the same to the user terminal 30-1 (step 002).

When the attribute certificate 80 is issued, the attribute certificate 80 should be formulated in a manner that permits the service provider apparatus 40 to check only the designated items ‘C (Country Name)’ and ‘O (Organization Name)’ in this embodiment in the holder field 83 thereof for comparison with the subject fields 73 of the public key certificates 70-i so that the user terminals 30-i can use the same attribute certificate 80. For that end, the user terminal 30-1 makes a request to the attribute authority apparatus 20 that the determination criteria corresponding to the item ‘C (Country Name)’ and ‘O (Organization Name)’ in the determination policy 86 be ‘To be verified’. The attribute authority apparatus 20 configures the determination policy 86 in accordance with the request made by the user terminal 30-1, and sets ‘To be verified’ in the determination criterion for the item ‘C (Country Name)’ and ‘To be verified’ in the determination criterion for the item ‘O (Organization Name)’.

The user terminal 30-1 has distributed, in advance, the attribute certificate 80 to the user terminals 30-i (step S003). Each of the user terminals 30-i stores the attribute certificate 80 in the certificate storage 34.

First, the service receiving unit 32 of a user terminal 30-i transmits a request (service request) for receiving a service which involves user authentication, to the service provider apparatus 40 (step S004). The service providing unit 43 of the service provider apparatus 40 receives the service request transmitted from the user terminal 30-i (step S005). Upon receipt of the service request in step S005, the service providing unit 43 transmits a request for an attribute certificate and a public key certificate which are required for verifying the eligibility of the relevant user, to the user terminal 30-i (step S006). The request for attribute and public key certificates contains random-number data for causing the user terminal 30-i to affix a signature of the user to the certificates to ensure that an entity who presents the public key certificate 70-i is a holder of the public key certificate 70-i.

The service receiving unit 32 of the user terminal 30-i receives the request for attribute and public key certificates transmitted from the service provider apparatus 40 (step S007). Upon receipt of the request for attribute and public key certificates in step S007, the service receiving unit 32 instructs the certificate managing unit 33 to obtain the public key certificate 70-i and the attribute certificate 80 of the user terminal 30-i from the certificate storage 34, and to obtain a private key corresponding to the public key certificate 70-i from the private key storage 35 and to affix a signature to the random-number data. The certificate managing unit 33 obtains the public key certificate 70-i and the attribute certificate 80 from the certificate storage 34, and obtains a private key corresponding to the public key certificate 70-i from the private key storage 35, and affixes a signature to the random-number data. The certificate managing unit 33 then transmits the public key certificate 70-i and the attribute certificate 80 of the user terminal 30-i, and the random-number data with a signature affixed thereto, to the service receiving unit 32. The service receiving unit 32 transmits the public key certificate 70-i and the attribute certificate 80 of the user terminal 30-i, and the random-number data with a signature affixed thereto, to the service provider apparatus 40 (step S008).

The service providing unit 43 of the service provider apparatus 40 receives the public key certificate 70-i and the attribute certificate 80, and the random-number data with a signature affixed thereto, which have been transmitted from the user terminal 30-i (step S009). The attribute certificate verification unit 42 of the service provider apparatus 40 verifies the attribute certificate 80, using the public key certificate 70-i and the attribute certificate 80 of the user terminal 30-i, and the random-number data with a signature affixed thereto, so as to ensure that the user terminal 30-i is entitled to use the attribute certificate 80 (step S010).

If the attribute certificate verification unit 42 confirms (OK in step S010) that the attribute certificate 80 is valid, then the service providing unit 43 retrieves the attribute information 85 from the attribute certificate 80, and obtains service providing data corresponding to the attribute information 85 from the service providing data storage 44. In the present embodiment, the service providing data obtained by the service providing unit 43 contain prices reduced at 10% from the ordinary prices. Then, the service providing unit 43 of the service provider apparatus 40 transmits a service response to the user terminal 30-i (step S011). The service receiving unit 32 of the user terminal 30-i receives the service response (step S012).

If the attribute certificate verification unit 42 fails to confirm (NG in step S010) that the attribute certificate is valid, then the service providing unit 43 generates a service request denial message, and transmits the same to the user terminal 30-i (step S013). The service receiving unit 32 of the user terminal 30-i receives the service request denial message (step S014).

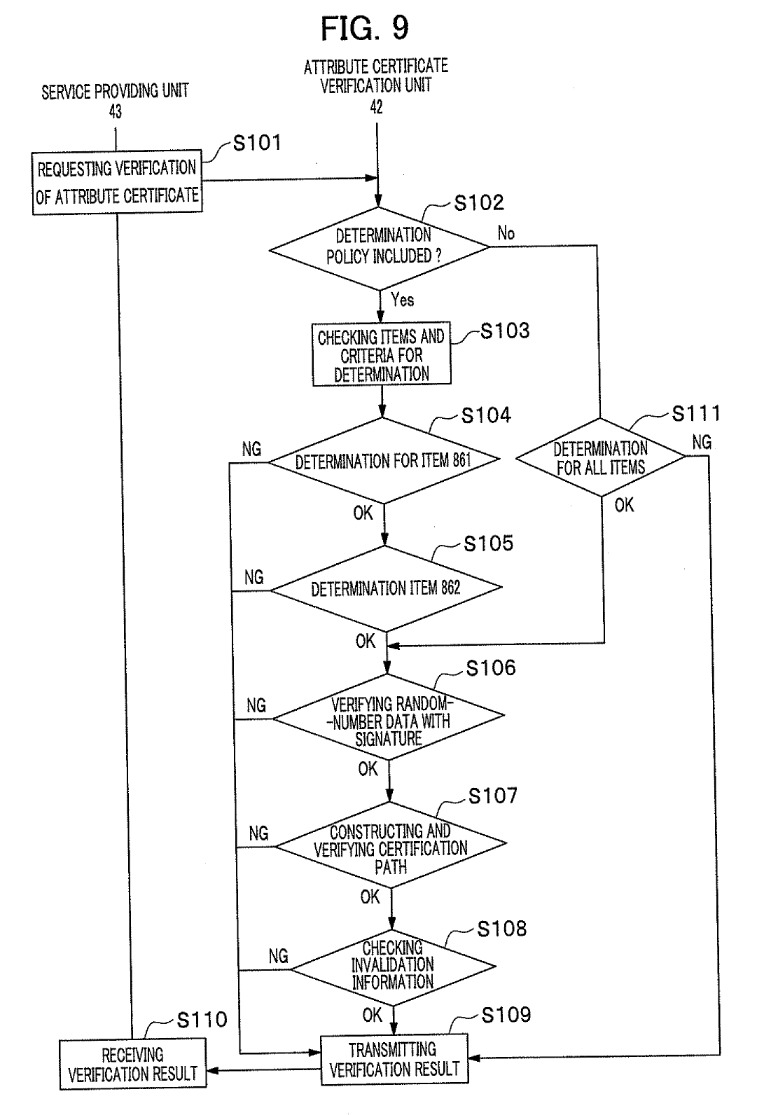

FIG. 9 is a flowchart showing a detailed process, to be executed by the attribute certificate verification unit 42 of the service provider apparatus 40, for verifying an attribute certificate according to an exemplary embodiment. If the service providing unit 43 receives a public key certificate 70-i, an attribute certificate 80, and random-number data with a signature affixed thereto, from the user terminal 30-i, then the service providing unit 43 forwards the public key certificate 70-i, the attribute certificate 80, and the random-number data with a signature affixed thereto, to the attribute certificate verification unit 42, to request verification of the attribute certificate 80 (step S101). The attribute certificate verification unit 42 determines whether or not the attribute certificate 80 contains a determination policy 86 (step S102).

If it is determined that the attribute certificate 80 contains a determination policy 86 (Yes in step S102), then the attribute certificate verification unit 42 checks items to be checked for determination to be made to verify a linkage between the public key certificate 70-i and the attribute certificate 80, and criteria for the determination, based upon the determination policy 86 (step S103). In the present embodiment, as shown in FIG. 7, items 861 and 862 in the determination policy field 86 are filled in with ‘C (Country Name)’ and ‘O (Organization Name)’ and corresponding determination criteria are designated as ‘To be verified’, and thus the attribute certificate verification unit 42 confirms that the ‘C (Country Name)’ and ‘O (Organization Name)’ alone are designated as items to be checked for determination.

The attribute certificate verification unit 42 compares values of the item 861 designated in the determination policy 86 between data recorded in the holder field 83 of the attribute certificate 80 and data recorded in the subject field 73 of the public key certificate 70-i (see FIG. 6) (step S104). To be more specific, since the item 861 of the determination policy 86 designates ‘C (Country Name)’ as an item to be checked for determination and ‘To be verified’ as a corresponding determination criterion, comparison is made between the value in item 731 of the public key certificate 70-i and the value in item 831 of the attribute certificate 80. If it is determined that the value in item 731 is identical to the value in item 831 (OK in step S104), then the process goes to step S105 in which the item 862 designated in the determination policy 86 is verified. If it is determined that the value in item 731 is not identical to the value in item 831 (NG in step S104), then the attribute certificate verification unit 42 determines that a linkage between the public key certificate 70-i and the attribute certificate 80 is not confirmed, thus producing a verification result to the effect that the attribute certificate 80 is invalid, and proceeds to step S109 in which the verification result is transmitted out. In the present embodiment, the item 731 of the public key certificate 70-i and the item 831 of the attribute certificate 80 both have the same value “JP” in ‘C (Country Name)’, and thus the process goes to step S105.

The attribute certificate verification unit 42 compares values of the item 862 designated in the determination policy 86 between data recorded in the holder field 83 of the attribute certificate 80 and data recorded in the subject field 73 of the public key certificate 70-i (step S105). To be more specific, since the item 862 of the determination policy 86 designates ‘O (Organization Name)’ as an item to be checked for determination and ‘To be verified’ as a corresponding determination criterion, comparison is made between the value in item 732 of the public key certificate 70-i and the value in item 832 of the attribute certificate 80. If it is determined that the value in item 732 is identical to the value in item 832 (OK in step S105), then the process goes to step S106 in which the random-number data is verified. If it is determined that the value in item 732 is not identical to the value in item 832 (NG in step S105), then the attribute certificate verification unit 42 determines that a linkage between the public key certificate 70-i and the attribute certificate 80 is not confirmed, thus producing a verification result to the effect that the attribute certificate 80 is invalid, and proceeds to step S109 in which the verification result is transmitted out. In the present embodiment, the item 732 of the public key certificate 70-i and the item 832 of the attribute certificate 80 both have the same value “Company A” in ‘O (Organization Name)’, and thus the process goes to step S106.

The verification process as in step 104 or 105 is repeated for each item to be checked for determination with a corresponding determination criterion recorded in the determination policy 86. In the present embodiment, the number of the items to be checked for determination with corresponding determination criteria are two (i.e., 861 and 862), and thus the verification process is repeated twice as described above.

If it is determined that the attribute certificate 80 fails to contain a determination policy 86 (No in step S102), then the attribute certificate verification unit 42 determines, as in the conventional scheme, whether or not the values of all the items in the holder field 83 of the attribute certificate 80 are identical to the values of corresponding items in the subject field 73 of the public key certificate 70-i (step S111). If it turns out that the values of every pair of the items are identical to each other (OK in step S111), then the process goes to step S106 in which the random-number data with a signature affixed thereto are verified. If it turns out that the values of any pair of the items are not identical to each other (NG in step S111), then the attribute certificate verification unit 42 determines that a linkage between the public key certificate 70-i and the attribute certificate 80 is not confirmed, thus producing a verification result to the effect that the attribute certificate 80 is invalid, and proceeds to step S109 in which the verification result is transmitted out.

If the linkage between the public key certificate 70-i and the attribute certificate 80 is confirmed (OK) in step S105 or S111, then the attribute certificate verification unit 42 verifies the random-number data with a signature affixed thereto which has been presented by the user terminal 30-i, using the public key certificate 70-i (step S106). If the random-number data with a signature affixed thereto is verified successfully (OK in step S106), then the process goes to step S107 in which a certification path is constructed and verified. If the random-number data with a signature affixed thereto is not verified (NG in step S106), then the attribute certificate verification unit 42 produces a verification result to the effect that the attribute certificate 80 is invalid, and proceeds to step S109 in which the verification result is transmitted out.

If the random-number data is verified successfully in step S106, the attribute certificate verification unit 42 obtains a certificate of the certificate authority trusted by the service provider apparatus 40 which certificate is stored in the trust anchor information storage 45, and constructs and verifies a certification path indicating certification ranging from the obtained certificate through the public key certificate 70-i and the attribute certificate 80 (step S107). If the certification path is constructed and verified successfully (OK in step S107), then the process goes to step S108 in which invalidation information is checked to confirm the validity of the certificates. If construction and verification of the certificate path fails (NG in step S107), then the attribute certificate verification unit 42 produces a verification result to the effect that the attribute certificate 80 is invalid, and proceeds to step S109 in which the verification result is transmitted out.

If the certification path is constructed and verified successfully in step S107, then the attribute certificate verification unit 42 obtains, from all the certificates making up the certification path, location information on locations at which the invalidation information is released to public (the invalidation information of the public key certificate 70-i released by the invalidation information publisher 13 of the certificate authority apparatus 10 and the invalidation information of the attribute certificate 80 released by the invalidation information publisher 23 of the attribute authority apparatus 20), and then obtains the invalidation information for each certificate from the locations designated by the location information, to verify the validity of each certificate (step S108). If the validity of all the certificates making up the certification path is verified (OK in step S108), then the attribute certificate verification unit 42 produces a verification result to the effect that the attribute certificate 80 is valid, and proceeds to step S109 in which the verification result is transmitted out. If any of the certificates making up the certification path turns out to be an invalidated one or fails to provide positive proof of validity (NG in step S108), then the attribute certificate verification unit 42 produces a verification result to the effect that the attribute certificate 80 is invalid, and proceeds to step S109 in which the verification result is transmitted out. The attribute certificate verification unit 42 transmits the verification result of the attribute certificate 80 to the service providing unit 43 (step S109). The service providing unit 43 receives the verification result of the attribute certificate 80 from the attribute certificate verification unit 42 (step S110).

It is to be understood that the steps of determination for item 861 (S104), determination for item 862 (S105), verification of random-number data with signature (S106), construction and verification of certification path (S107) and checking of invalidation information (S108), all of which are performed in the attribute certificate verification unit 42, may occur in any desired order. For example, steps S104 and S105 may come after verification of random-number data with signature in step S106. Similarly, the steps to be performed if determination for all the items results in OK in step S111, i.e., verification of random-number data with signature (S106), construction and verification of certification path (S107) and checking of invalidation information (S108), may occur in any order, as well.

It is to be understood that the certificate storage 34 of the user terminal 30-i may store only the public key certificate 70-i while leaving the attribute certificate 80 stored in the attribute authority apparatus 20. In this configuration, the random-number data with a signature affixed thereto and the public key certificate 70-i alone the user terminal 30-i may transmit to the service provider apparatus 40, while the service provider apparatus 40 may obtain the attribute certificate 80 from the attribute authority apparatus 20.

The service provider apparatus 40 in this embodiment includes attribute certificate verification unit 42, and it is the service provider apparatus 40 that performs the steps S102-S109 of FIG. 9, but in an alternative embodiment, an external attribute certificate verification apparatus may be provided to assume the same process instead, which offloads the verification of the attribute certificate 80 from the service provider apparatus 40.

Through the aforementioned process, the user terminal 30-i can use the attribute certificate 80 associated with the public key certificate 70-i.

According to the present embodiment, the attribute authority apparatus 20 of the attribute authority responsible for issuance of the attribute certificate 80 is configured to record, in the holder field 83 of the attribute certificate 80 with the entityName option applied thereto, information recorded in the subject field 73 of the public key certificate 70-i of the user, and record, in the extension field of the attribute certificate 80, a determination policy 86, which comprises information designating one or more items to be checked by the service provider apparatus 40 for determination to be made to verify a linkage between the public key certificate 70-i and the attribute certificate 80, and criteria for the determination. When the service provider apparatus 40 in turn verifies the linkage between the public key certificate 70-i and the attribute certificate 80, the service provider apparatus 40 obtains the determination policy 86 recorded in the attribute certificate 80, and determines whether or not the data in the one or more items (e.g., items 861, . . . , 864) designated in the determination policy 86 fulfill the criteria recorded in the determination policy 86, by comparing information recorded in the holder field 83 of the attribute certificate 80 with information recorded in the subject field 73 of the public key certificate 70-i. Accordingly, a single attribute certificate 80 associated with a plurality of public key certificates 70-i can be utilized.

### Second Embodiment

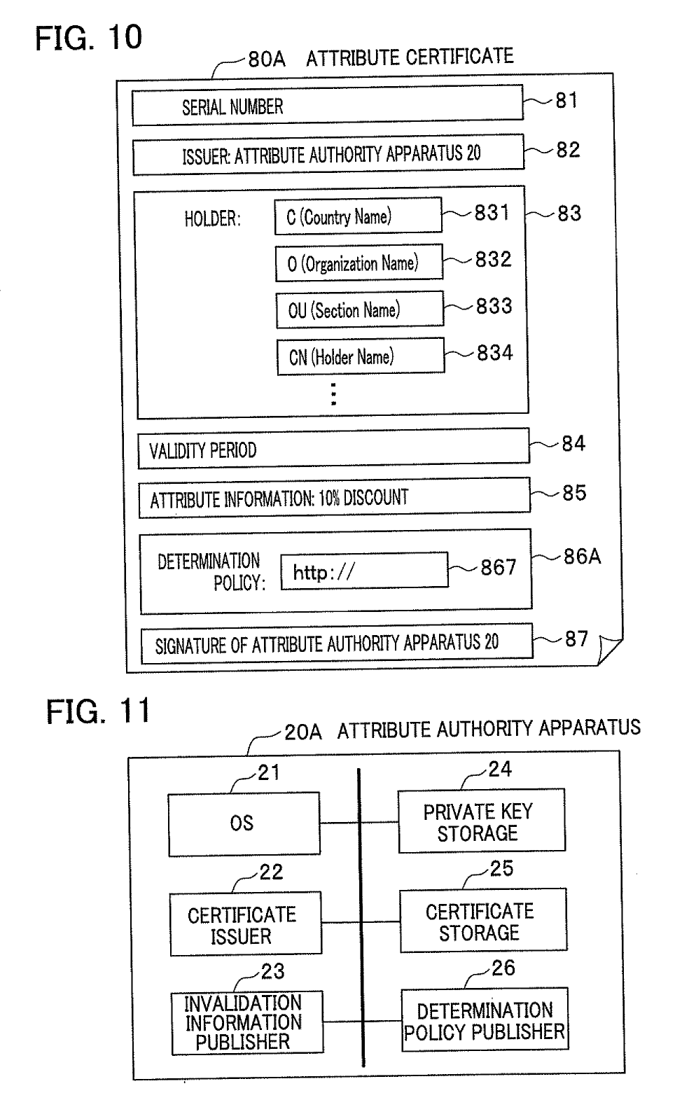

FIG. 10 shows data specifications of an attribute certificate of a user terminal according to a second exemplary embodiment of the present invention. As shown in FIG. 10, the items of information included in the field 86A for designating the determination policy is different from those included in the field 86 for designating the determination policy as shown in FIG. 7, implemented according to the first embodiment. In FIG. 10, the same elements as in FIG. 7 are designated by the same reference numerals, and a duplicate description thereof will be omitted. In item 867 of determination policy field 86A is recorded information (location information) for obtaining the determination policy 86, such as an URI at which it is released to public. In the first embodiment, the items to be checked for determination to be made to verify the attribute certificate 80, i.e., the linkage with the public key certificate 70-i, and the criteria for the determination (e.g., items 861, . . . , 864) are recorded in the determination policy field 86. In contrast, in the second embodiment, a location at which are released the items to be checked for determination and the determination criteria for each item is designated (i.e., location information thereof is recorded) in the determination policy field 86A. To be more specific, the service provider apparatus 40 consults item 867 for the URI, and obtains the determination policy from the designated location at which the determination policy is released to public by the attribute authority apparatus 20.

FIG. 11 shows a software configuration of an attribute authority apparatus according to the second embodiment. As shown in FIG. 11, the attribute authority apparatus 20A is configured to comprise a determination policy publisher 26 in addition to the elements of the attribute authority apparatus 20 as shown in FIG. 3, implemented according to the first embodiment. In FIG. 11, the same elements as in FIG. 3 are designated by the same reference numerals, and a duplicate description thereof will be omitted. The determination policy publisher 26 holds, or releases to public, information corresponding to items 861 and 862 of the determination policy 86 (not shown) for recording the items to be checked for determination to be made to verify the attribute certificate 80, i.e., the linkage with the public key certificate 70-i, and the criteria for the determination.

In operation, described next is a modified process in step S102 of FIG. 9, which is different from the process as implemented according to the first embodiment. The attribute certificate verification unit 42 of the service provider apparatus 40 obtains location information recorded in the determination policy field 86A of the attribute certificate 80A and goes to a site designated by the location information (i.e., URI). The attribute certificate verification unit 42 then determines whether or not a relevant determination policy is released to public at that site by the determination policy publisher 26 (step S102). Operation in the other steps of the present embodiment is substantially the same as those of the first embodiment which have been described with reference to FIG. 9, and thus a duplicate description will be omitted.

It is to be understood that the service provider apparatus 40 may, in step S102, not necessarily obtain a determination policy from the location at which it is released to public by the attribute authority apparatus 20 at each time when verification is to be made, but may rather cache the determination policy in a memory of the service provider apparatus 40 to verify a linkage between the public key certificate 70-i and the attribute certificate 80A using the cached determination policy.

According to the present embodiment, the attribute authority apparatus 20 of the attribute authority responsible for issuance of the attribute certificate 80A is configured to record, in the holder field 83 of the attribute certificate 80A with the entityName option applied thereto, information recorded in the subject field 73 of the public key certificate 70-i of the user, and release one or more items 861 and 862 of information to public for use in verification of the linkage between the attribute certificate 80A and the public key certificate 70-i, and record, in the extension field of the attribute certificate 80A, location information of the location at which the items 861 and 862 are released to public, wherein the items 861 and 862 comprise information designating one or more items to be checked by the service provider apparatus 40 for determination to be made to verify the attribute certificate 80A, i.e., the linkage with the public key certificate 70-i, and criteria for the determination. When the service provider apparatus 40 in turn verifies the linkage between the public key certificate 70-i and the attribute certificate 80A, the service provider apparatus 40 obtains the location information recorded in the attribute certificate 80A, accesses the site at that location designated by the location information to obtain the determination policy, and determines whether or not the data in the one or more items 861 and 862 designated in the determination policy fulfill the criteria recorded in the determination policy, by comparing information recorded in the holder field 83 of the attribute certificate 80A with information recorded in the subject field 73 of the public key certificate 70-i. Accordingly, a single attribute certificate 80A associated with a plurality of public key certificates 70-i can be utilized.

### Third Embodiment

The first and second embodiments are designed to obviate the necessity for modification or the like in the prevailing format of the public key certificates that have already been used widely, but premised on the use of a modified format of attribute certificates. The first and second embodiments are also designed on the premise that an attribute certificate is re-issued and re-distributed every time when the determination policy or the location at which the determination policy is released to public is changed after the attribute certificate is issued.

The third embodiment, as well as a fourth embodiment which will be described later, provides alternative methods in which no modification in the formats of the public key and attribute certificates is necessitated, and no re-issuance/re-distribution of the attribute certificate is necessitated even when the determination policy or the location at which the determination policy is released to public is changed after the attribute certificate is issued.

In the third embodiment, the attribute authority apparatus is configured to issue an attribute certificate with no determination policy recorded therein, and issue a determination policy certificate.

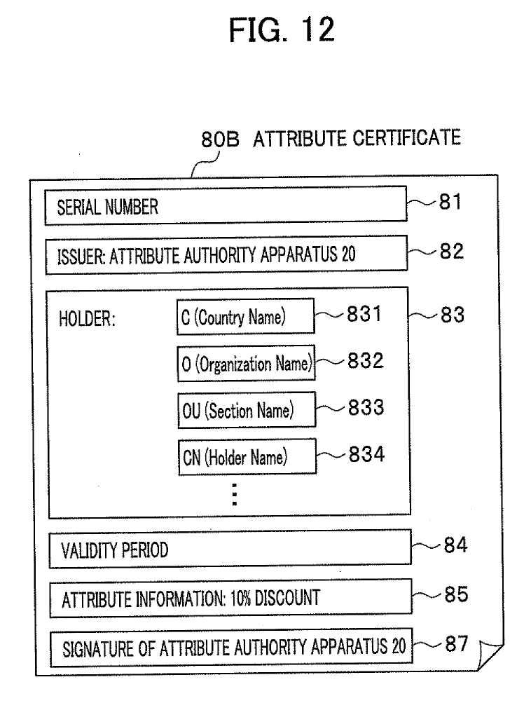

FIG. 12 shows data specifications of an attribute certificate of a user terminal according to the third embodiment of the present invention. As shown in FIG. 12, no field for designating a determination policy 86 or 86A as shown in FIGS. 7 and 10 and implemented according to the first and second embodiments, is provided in the attribute certificate 80B. In FIG. 12, the same elements as in FIGS. 7 and 10 are designated by the same reference numerals, and a duplicate description thereof will be omitted.

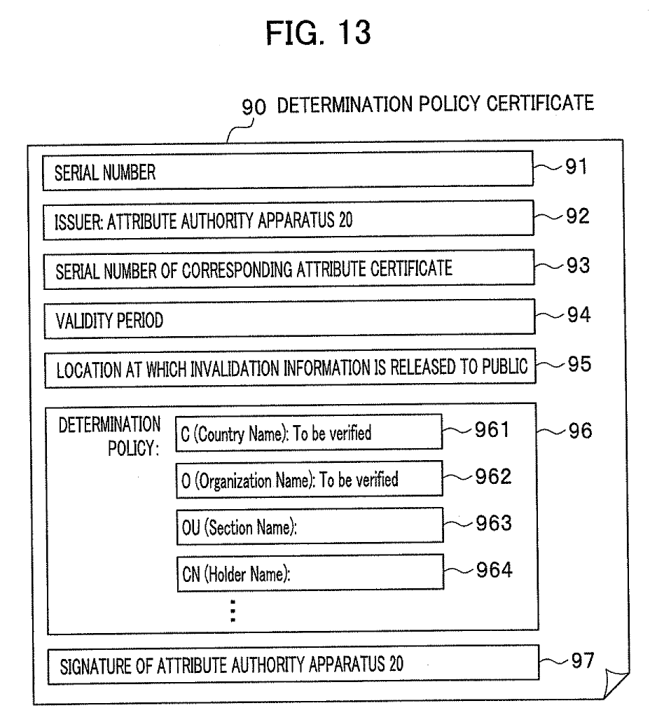

FIG. 13 shows data specifications of a determination policy certificate. The determination policy certificate 90 has fields of a serial number 91 of the determination policy certificate 90, an issuer 92 of the determination policy certificate 90, a serial number 93 of the corresponding attribute certificate, a validity period 94 of the determination policy certificate 90, a location 95 at which invalidation information of the determination policy certificate 90 is released to public, and a determination policy 96. The determination policy certificate 90 consists of data with an electronic signature 97 affixed thereto by means of a private key of the attribute authority apparatus 20 (see FIG. 3). Assume that the contents recorded in the determination policy field 96 in the present embodiment are the same as those recorded in the determination policy field 86 of the attribute certificate 80 as shown in FIG. 7 according to the first embodiment. The determination policy certificate 90 has been issued to the user terminal 30-i (i=1, . . . , n) by the certificate issuer 22 of the attribute authority apparatus 20 when the attribute certificate 80B is issued or when the determination policy is changed. The determination policy certificate 90, which has thus been issued in advance, is stored in the certificate storage 34 of the user terminal 30-i (30-1, . . . , 30-n) (see FIG. 4), together with the public key certificate 70-i and attribute certificate 80B.

It is to be understood that a plurality of serial numbers 93 of the corresponding attribute certificates 80B may be recorded in the determination policy certificate 90. In that case, all that is required when a determination policy common to a plurality of attribute certificates 80B is changed is to re-issue and re-distribute just a single determination policy certificate 90 which provides the common determination policy. Accordingly, the operation of issuing and distributing one determination policy certificate 90 containing the common determination policy, which would otherwise be repeated for each of the other attribute certificates 80B, can be completed in a single operation of issuing and distributing one and the same determination policy certificate 90, thus reducing the load on the certificate issuer 22 of the attribute authority apparatus 20.

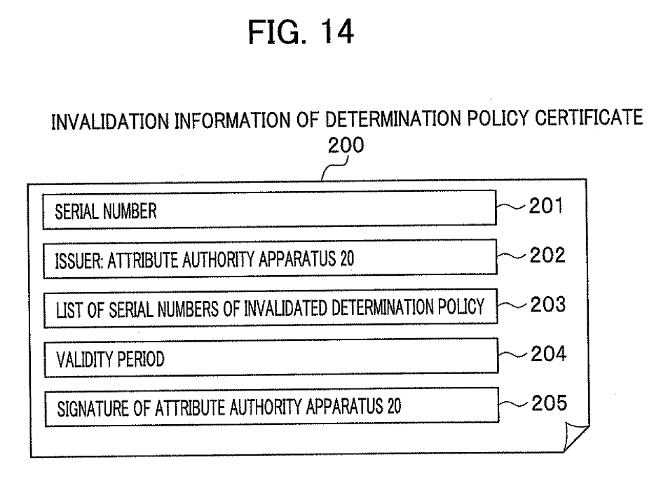

FIG. 14 shows data specifications of invalidation information of the determination policy certificate(s). The invalidation information 200 of the determination policy certificate(s) contains a serial number 201 of the invalidation information 200, an issuer 202 of the invalidation information 200, a list 203 of serial numbers of invalidated determination policy certificate(s), a validity period 204 of the invalidation information 200. The invalidation information 200 consists of data with an electronic signature 205 affixed thereto by means of a private key of the attribute authority apparatus 20. The invalidation information 200 of the determination policy certificate(s) is issued by the certificate issuer 22 of the attribute authority apparatus 20 at regular intervals within the validity period or at a time when a determination policy certificate expires or is invalidated. The invalidation information 200, which is thus issued, is released to public by the invalidation information publisher 23.

When the user terminal 30-i checks the invalidation information 200 of the determination policy certificate 90, the user terminal 30-i may consult the determination policy certificate 90 for the location 95 at which the invalidation information 200 is released to public to obtain the location information of the invalidation information 200 of the determination policy certificate 90, and may obtain the invalidation information 200 from the site designated by the location information. For example, when the user terminal 30-i manages a plurality of determination policy certificates 90 and becomes indeterminable which determination policy certificate is currently valid, the user terminal 30-i can check the invalidation information 200 of the determination policy certificate 90, to ensure which is the valid determination policy certificate 90.

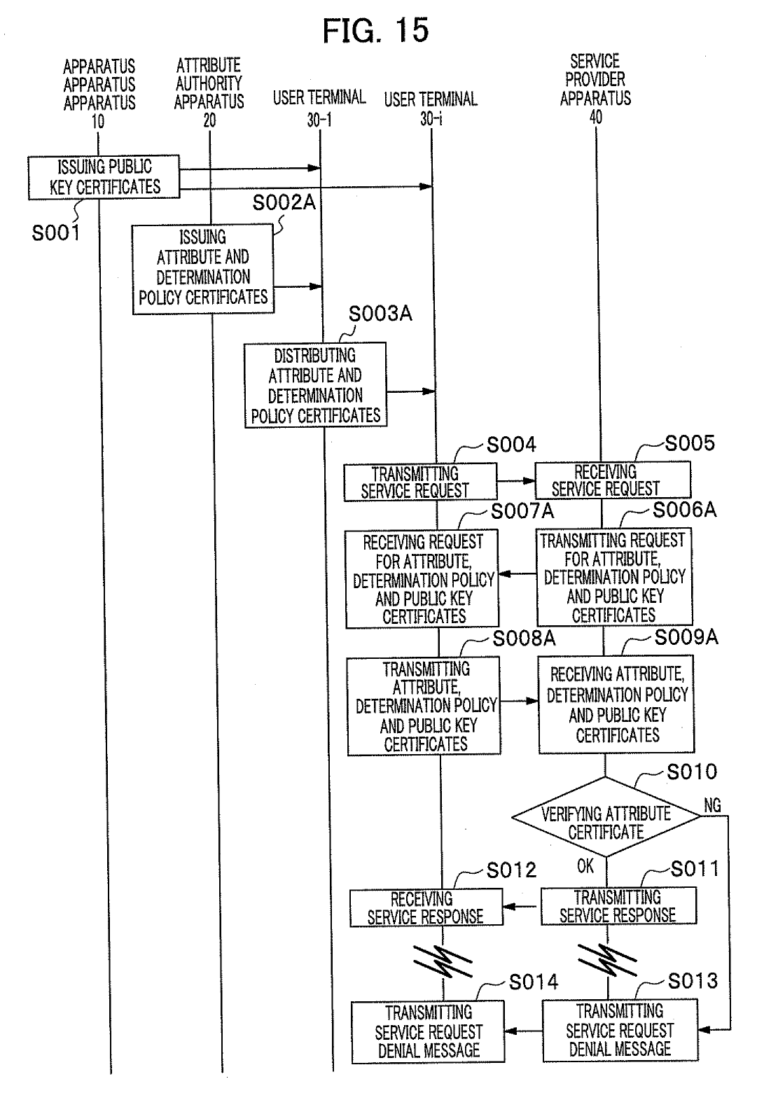

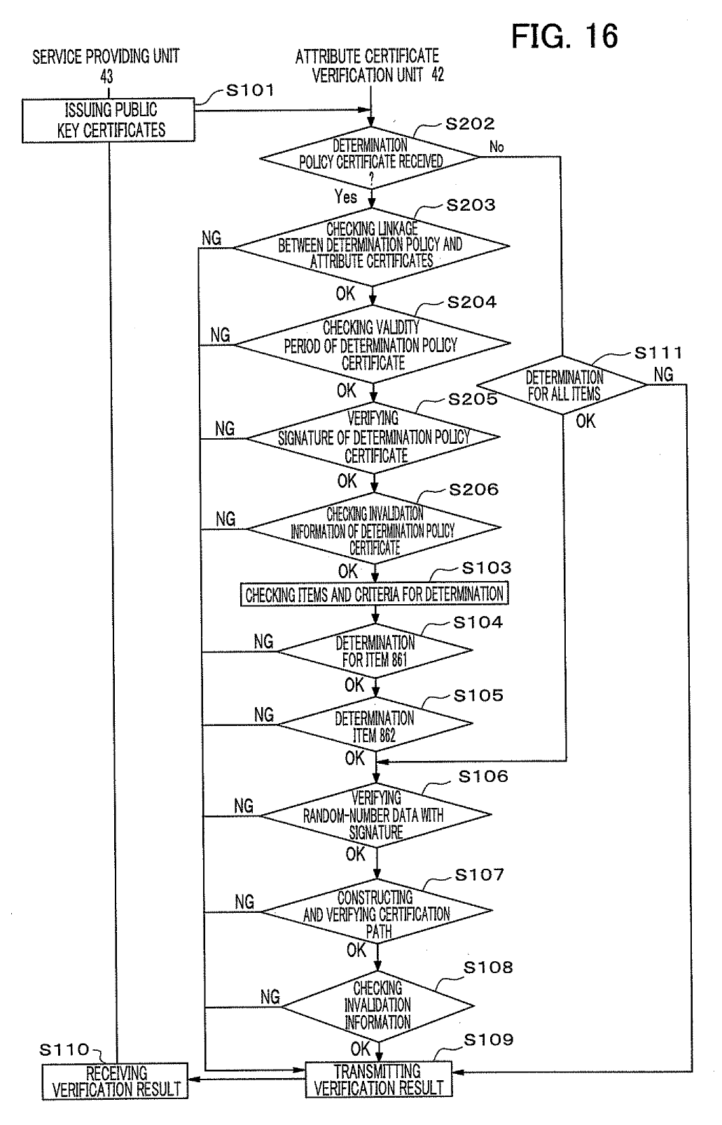

FIG. 15 is a flowchart showing a process for allowing a user terminal to receive a service from a service provider apparatus according to the third embodiment. In FIG. 15, the same steps as in FIG. 8 are designated by the same reference numerals. The certificate authority apparatus 10 has issued, in advance, public key certificates 70-1, . . . , 70-i (i=2, . . . , n in FIG. 15) to user terminals 30-1, . . . , 30-i (i=2, . . . , n in FIG. 15) (step S001). The public key certificates 70-1, . . . , 70-i, thus issued, are stored in the certificate storage 34 of each user terminal. The attribute authority apparatus 20 has associated, in advance, the attribute certificate 80B and the determination policy certificate 90 with the public key certificate 70-1, and has issued the same to the user terminal 30-1 (step 002A).

When the determination policy certificate 90 is issued, the user terminal 30-1 makes a request to the attribute authority apparatus 20 that the determination criteria corresponding to the item ‘C (Country Name)’ 961 and the item ‘O (Organization Name)’ 962 in the determination policy 96 be ‘To be verified’, so that the user terminals 30-i can use the same attribute certificate 80B. The attribute authority apparatus 20 configures the determination policy 96 in accordance with the request made by the user terminal 30-1, and sets ‘To be verified’ in the determination criterion for the item ‘C (Country Name)’ 961 and ‘To be verified’ in the determination criterion for the item ‘O (Organization Name)’ 962.

The user terminal 30-1 has distributed, in advance, the attribute certificate 80B and the determination policy certificate 90 to the user terminals 30-i (step S003A). Each of the user terminals 30-i stores the attribute certificate 80B and the determination policy certificate 90 in the certificate storage 34.

First, the service receiving unit 32 of a user terminal 30-i transmits a request (service request) for receiving a service which involves user authentication, to the service provider apparatus 40 (step S004). The service providing unit 43 of the service provider apparatus 40 receives the service request transmitted from the user terminal 30-i (step S005). Upon receipt of the service request in step S005, the service providing unit 43 transmits a request for an attribute certificate, a determination policy certificate and a public key certificate which are required for verifying the eligibility of the relevant user, to the user terminal 30-i (step S006A). The request for attribute, determination policy and public key certificates contains random-number data for causing the user terminal 30-i to affix a signature of the user to the certificates to ensure that an entity who presents the public key certificate 70-i is a holder of the public key certificate 70-i.

The service receiving unit 32 of the user terminal 30-i receives the request for attribute, determination policy and public key certificates transmitted from the service provider apparatus 40 (step S007A). Upon receipt of the request for attribute, determination policy and public key certificates in step S007A, the service receiving unit 32 instructs the certificate managing unit 33 to obtain the public key certificate 70-i and the attribute certificate 80B of the user terminal 30-i, and the determination policy certificate 90 from the certificate storage 34, and to obtain a private key corresponding to the public key certificate 70-i from the private key storage 35 and to affix a signature to the random-number data. The certificate managing unit 33 obtains the public key certificate 70-i, the attribute certificate 80B and the determination policy certificate 90 from the certificate storage 34, and obtains a private key corresponding to the public key certificate 70-i from the private key storage 35, and affixes a signature to the random-number data. The certificate managing unit 33 then transmits the public key certificate 70-i, the attribute certificate 80B, and the random-number data with a signature affixed thereto, to the service receiving unit 32. The service receiving unit 32 transmits the public key certificate 70-i and the attribute certificate 80B of the user terminal 30-i, the determination policy certificate 90, and the random-number data with a signature affixed thereto, to the service provider apparatus 40 (step S008A).

The service providing unit 43 of the service provider apparatus 40 receives the public key certificate 70-i, the attribute certificate 80B, the determination policy certificate 90, and the random-number data with a signature affixed thereto, which have been transmitted from the user terminal 30-i (step S009A). The attribute certificate verification unit 42 of the service provider apparatus 40 verifies the attribute certificate 80B, using the public key certificate 70-i and the attribute certificate 80B of the user terminal 30-i, the determination policy certificate 90, and the random-number data with a signature affixed thereto, so as to ensure that the user terminal 30-i is entitled to use the attribute certificate 80B (step S010).

If the attribute certificate verification unit 42 confirms (OK in step S010) that the attribute certificate 80B is valid, then the service providing unit 43 retrieves the attribute information 85 from the attribute certificate 80B, and obtains service providing data corresponding to the attribute information 85 from the service providing data storage 44. In the present embodiment, the service providing data obtained by the service providing unit 43 contain prices reduced at 10% from the ordinary prices. Then, the service providing unit 43 of the service provider apparatus 40 transmits a service response to the user terminal 30-i (step S011). The service receiving unit 32 of the user terminal 30-i receives the service response (step S012).

If the attribute certificate verification unit 42 fails to confirm (NG in step S010) that the attribute certificate 80 is valid, then the service providing unit 43 generates a service request denial message, and transmits the same to the user terminal 30-i (step S013). The service receiving unit 32 of the user terminal 30-i receives the service request denial message (step S014).

FIG. 16 is a flowchart showing a detailed process, to be executed by the attribute certificate verification unit 42 of the service provider apparatus 40, for verifying an attribute certificate according to the third embodiment. If the service providing unit 43 receives a public key certificate 70-i, an attribute certificate 80B, a determination policy certificate 90, and random-number data with a signature affixed thereto from the user terminal 30-i, then the service providing unit 43 forwards the public key certificate 70-i, the attribute certificate 80B, the determination policy certificate 90, and the random-number data with a signature affixed thereto, to the attribute certificate verification unit 42, to request verification of the attribute certificate 80B (step S101). The attribute certificate verification unit 42 determines whether or not the data received from the service providing unit 43 contains a determination policy certificate 90 (step S202).

If it is determined that the data received from the service providing unit 43 contains a determination policy certificate 90 (Yes in step S202), then the attribute certificate verification unit 42 checks the correspondences between the issuer 82 of the attribute certificate 80B and the issuer 92 of the determination policy certificate 90, between the serial number 81 of the attribute certificate 80B and the serial number 93 of the corresponding attribute certificate recorded in the determination policy certificate 90, to ensure that the determination policy certificate 90 is the determination policy certificate corresponding to the attribute certificate 80B (step S203). If the attribute certificate verification unit 42 confirms (OK in step S203) that the issuers and the serial numbers between the certificates 80B and 90 are identical to each other, then the process goes to step S204 in which the validity period of determination policy certificate is checked. If the attribute certificate verification unit 42 fails to confirm (NG in step S203) that the issuers and the serial numbers between the certificates 80B and 90 are identical to each other, then the attribute certificate verification unit 42 produces a verification result to the effect that the correspondence between the attribute certificate 80B and the determination policy certificate 90 is not verified, and proceeds to step S109 in which the verification result is transmitted out.

If it is determined that the data received from the service providing unit 43 fails to contain a determination policy certificate 90 (No in step S202), then the attribute certificate verification unit 42 determines, as in the conventional scheme, whether or not the values of all the items in the holder field 83 of the attribute certificate 80B are identical to the values of corresponding items in the subject field 73 of the public key certificate 70-i (step S111). If it turns out that the values of every pair of the items are identical to each other (OK in step S111), then the process goes to step S106 in which the random-number data with a signature affixed thereto are verified. If it turns out that the values of any pair of the items are not identical to each other (NG in step S111), then the attribute certificate verification unit 42 determines that a linkage between the public key certificate 70-i and the attribute certificate 80B is not confirmed, thus producing a verification result to the effect that the attribute certificate 80B is invalid, and proceeds to step S109 in which the verification result is transmitted out.

If the attribute certificate verification unit 42 confirms (OK in step S203) that the determination policy certificate 90 is the determination policy certificate corresponding to the attribute certificate 80B, then the attribute certificate verification unit 42 obtains information on the validity period 94 from the determination policy certificate 90, to ensure that the determination policy certificate 90 falls within the validity period (step S204). If it is determined that the determination policy certificate 90 falls within the validity period (OK in step S204), then the process goes to step S205 in which the signature of the determination policy certificate is verified. If it is determined that the determination policy certificate 90 fails to fall within the validity period (NG in step S204), then the attribute certificate verification unit 42 produces a verification result to the effect that the attribute certificate 80B is invalid, and proceeds to step S109 in which the verification result is transmitted out.

If it is determined that the determination policy certificate 90 falls within the validity period (OK in step S204), then the attribute certificate verification unit 42 obtains an electronic signature 97 of the attribute authority apparatus 20 from the determination policy certificate 90, and verifies the signature using the certificate of the attribute authority apparatus 20 stored in the trust anchor information storage 45 (step S205). If the signature is verified successfully (OK in step S205), then the process goes to step S206 in which the invalidation information of the determination policy certificate 90 is checked. If the signature of the determination policy certificate 90 is not verified (NG in step S206), then the attribute certificate verification unit 42 produces a verification result to the effect that the attribute certificate 80B is invalid, and proceeds to step S109 in which the verification result is transmitted out.

If the signature of the determination policy certificate 90 is verified successfully (OK in step S205), then the attribute certificate verification unit 42 consults the determination policy certificate 90 for the location 95 at which the invalidation information 200 is released to public by the invalidation information publisher 23 of the attribute authority apparatus 20, to obtain the location information of the invalidation information 200 of the determination policy certificate 90, and obtains the invalidation information 200 from the site designated by the location information to ensure that that the determination policy certificate 90 has not expired or been invalidated (step S206). If it turns out that the determination policy certificate 90 has not expired or been invalidated (OK in step S206), then the process goes to step S103 in which the items and criteria for the determination are checked. If it turns out that the determination policy 90 has expired or been invalidated (NG in step S206), then the attribute certificate verification unit 42 produces a verification result to the effect that the attribute certificate 80B is invalid, and proceeds to step S109 in which the verification result is transmitted out. Steps S103 through S111 proceed in the same manner as described in the first embodiment shown in FIG. 9, and thus a duplicate description will be omitted.

It is to be understood that the steps of checking the linkage between the determination policy certificate 90 and the attribute certificate 80B (S203), checking the validity period of the determination policy certificate 90 (S204), verifying the signature of the determination policy certificate 90 (S205), and checking the invalidation information of the determination policy certificate 90 (S206), all of which are performed in the attribute certificate verification unit 42, may occur in any order.

It is to be understood that the service provider apparatus 40, in step S206, may not necessarily obtain the invalidation information 200 of the determination policy certificate 90 from the location at which it is released to public by the attribute authority apparatus 20 at each time when verification is to be made, but may rather cache the invalidation information 200 of the determination policy certificate 90 in a memory of the service provider apparatus 40 to check the expiration/invalidation status of the determination policy certificate 90 using the cached invalidation information.

Through the aforementioned process, the user terminal 30-i can use the attribute certificate 80 associated with the public key certificate 70-i.

According to the present embodiment, the attribute authority apparatus 20 of the attribute authority responsible for issuance of the attribute certificate 80B is configured to record, in the holder field 83 of the attribute certificate 80B with the entityName option applied thereto, information recorded in the subject field 73 of the public key certificate 70-i of the user, and to record, in the determination policy field 96 of the determination policy certificate 90, one or more items to be checked by the service provider apparatus 40 for determination to be made to verify the attribute certificate 80B, i.e., the linkage with the public key certificate 70-i, and criteria for the determination. When the service provider apparatus 40 in turn verifies the linkage between the public key certificate 70-i and the attribute certificate 80B, the service provider apparatus 40 performs the steps of checking the linkage between the determination policy certificate 90 and the attribute certificate 80B, checking the validity period of the determination policy certificate 90, verifying the signature of the determination policy certificate 90, and checking the invalidation information of the determination policy certificate 90. If it is confirmed that the determination policy certificate 90 is valid (i.e., information for verifying the validity is ensured), then the service provider apparatus 40 obtains the determination policy 96, and determines whether or not the data in one or more items (e.g., items 961-964) designated in the determination policy 96 fulfill the criteria recorded in the determination policy 96, by comparing information recorded in the holder field 83 of the attribute certificate 80B with information recorded in the subject field 73 of the public key certificate 70-i. Accordingly, a single attribute certificate 80B associated with a plurality of public key certificates 70-i can be utilized.

### Fourth Embodiment

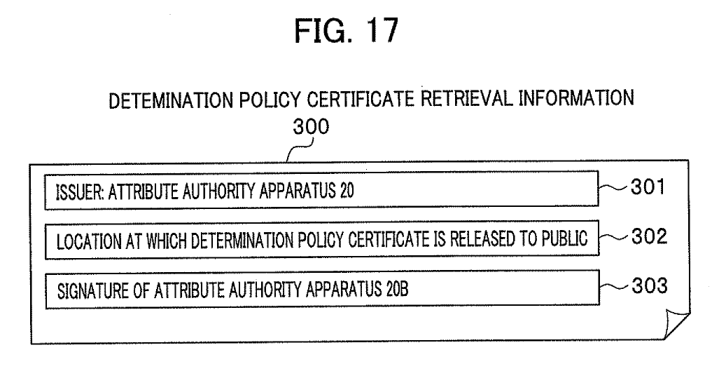

In the third embodiment, the attribute authority apparatus 20 releases invalidation information 200 of the determination policy certificate 90 to public, and the service provider apparatus 40 obtains the invalidation information 200 from a location at which the invalidation information is released to public by the attribute authority apparatus 20 at every time when validation and authentication are to be performed, or utilizes invalidation information cached in the service provider apparatus 40, so as to check the expiration/invalidation status of the determination policy certificate 90. In contrast, the fourth embodiment, like the second embodiment, the up-to-date determination policy certificate, instead of the invalidation information 200, is released to public by the attribute authority apparatus 20, and the user terminal 30-i furnishes the service provider apparatus 40 with determination policy certificate retrieval information 300 (see FIG. 17) which contains information on location (e.g., URI, etc.) at which the determination policy certificate is released to public, so that the service provider apparatus 40 retrieves the determination policy certificate 90.

FIG. 17 shows data specifications of determination policy certificate retrieval information 300. The determination policy certificate retrieval information 300 includes an issuer 301, and a location 302 at which a determination policy certificate is released to public. The determination policy certificate retrieval information 300 consists of data with a signature 303 of the attribute authority apparatus 20B affixed thereto. Specifically, the location 302 at which a determination policy certificate is released to public indicates an URI, etc.

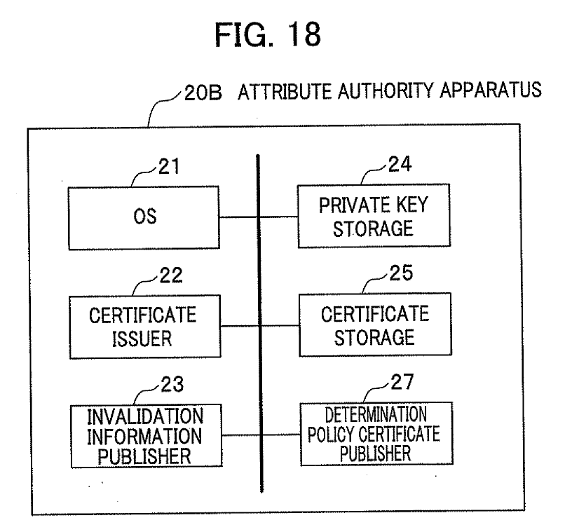

FIG. 18 shows a software configuration of an attribute authority apparatus according to yet another exemplary embodiment. When compared with FIG. 3, the attribute authority apparatus 20B further comprises a determination policy certificate publisher 27. In FIG. 18, the same elements as in FIG. 3 are designated by the same reference numerals, and a duplicate description thereof will be omitted. The determination policy certificate publisher 27 releases an up-to-date determination policy certificate 90 to public.

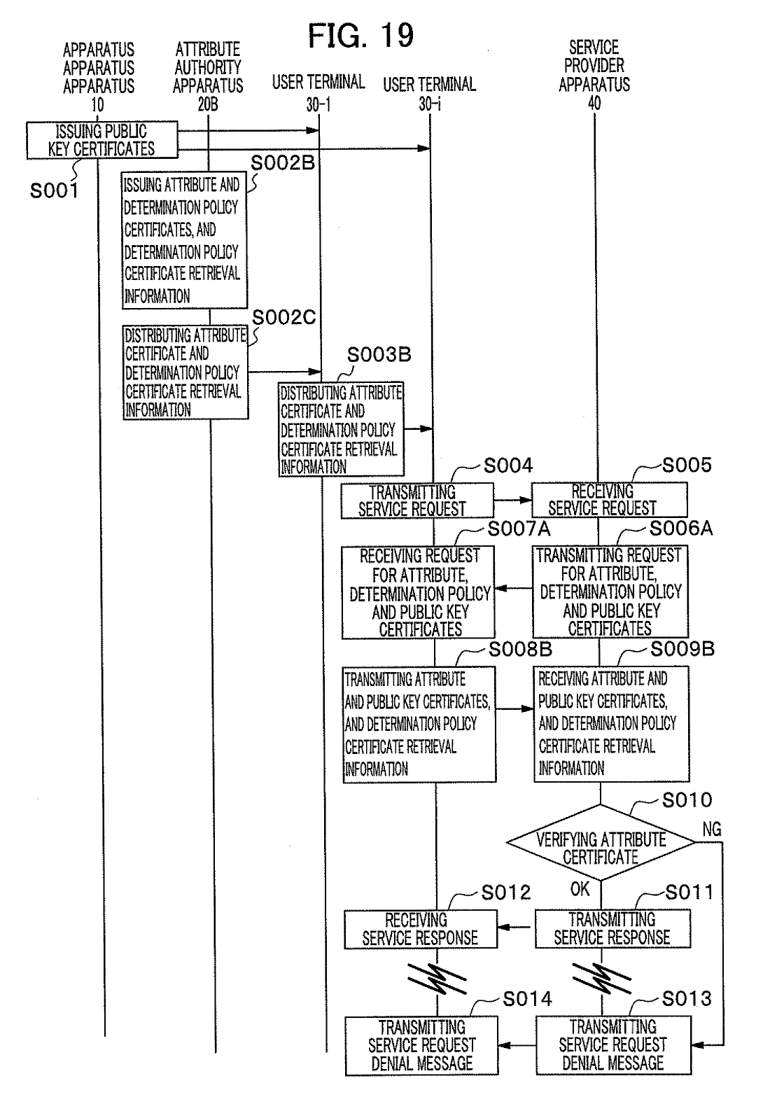

FIG. 19 is a flowchart showing a process for allowing a user terminal to receive a service from a service provider apparatus according to the fourth embodiment. In FIG. 19, the same steps as in FIGS. 8 and 15 are designated by the same reference numerals.

When the attribute authority apparatus 20B issues an attribute certificate 80B and a determination policy certificate 90, the attribute authority apparatus 20B also issues determination policy certificate retrieval information 300 (step S002B). The determination policy certificate 90 is released to public by the determination policy certificate publisher 27, while the determination policy certificate retrieval information 300 is distributed to the user terminal 30-1 (step S002C). The user terminal 30-1 has distributed, in advance, the attribute certificate 80B and the determination policy certificate retrieval information 300 to the user terminals 30-i (step S003B). Each of the user terminals 30-i stores the attribute certificate 80B and the determination policy certificate retrieval information 300 in the certificate storage 34. Steps S004 through S007A proceed in the same manner as described in the third embodiment shown in FIG. 15, and thus a duplicate description will be omitted.

The user terminal 30-i, in turn, when making a request for a service to the service provider apparatus 40, transmits the public key certificate 70-i, the attribute certificate 80B, the determination policy retrieval information 300, and the random-number data with a signature affixed thereto, to the attribute certificate verification unit 42 of the service provider apparatus 40 (step S008B).

Upon receipt of the service provider apparatus 40 receives the public key certificate 70-i of the user terminal 30-i, the attribute certificate 80B, the determination policy certificate retrieval information 300, and the random-number data with a signature affixed thereto, which are transmitted from the user terminal 30-i (step S009B), the attribute certificate verification unit 42 of the service provider apparatus 40 verifies the attribute certificate 80B (step S010). To be more specific, the attribute certificate verification unit 42 consults the determination policy certificate retrieval information 300 for the location 302 at which the determination policy certificate is released to public, and retrieves the location information of the up-to-date determination policy certificate to obtain the same from the site designated by the location information. Steps S011 through S014 proceed in the same manner as described in the third embodiment shown in FIG. 15, and thus a duplicate description will be omitted.

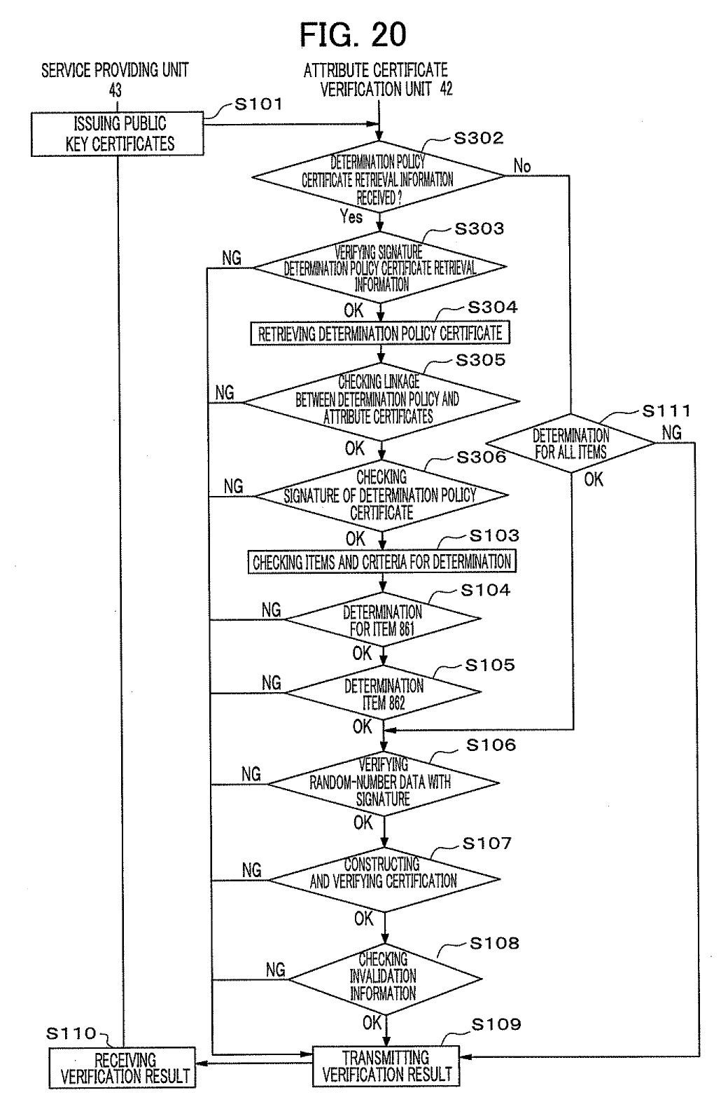

FIG. 20 is a flowchart showing a detailed process, to be executed by the attribute certificate verification unit 42 of the service provider apparatus 40, for verifying an attribute certificate according to the fourth embodiment. If the service providing unit 43 receives a public key certificate 70-i, an attribute certificate 80B, determination policy certificate retrieval information 300, and random-number data with a signature affixed thereto, from the user terminal 30-i, then the service providing unit 43 forwards the public key certificate 70-i, the attribute certificate 80B, the determination policy certificate retrieval information 300, and the random-number data with a signature affixed thereto, to the attribute certificate verification unit 42, to request verification of the attribute certificate 80B (step S101). The attribute certificate verification unit 42 of the service provider apparatus 40 determines whether or not data received from the service providing unit 43 contain determination policy certificate retrieval information 300 (step S302).

If it is determined that the data received from the service providing unit 43 contain determination policy certificate retrieval information 300 (Yes in step S302), then the attribute certificate verification unit 42 obtains a signature 303 of the attribute authority apparatus 20B from the determination policy certificate retrieval information 300, and verifies the signature using the certificate of the attribute authority apparatus 20B stored in the trust anchor information storage 45 (step S303). If the signature is verified successfully (OK in step S303), then the process goes to step S304 in which a determination policy certificate is obtained.

If it is determined that the data received from the service providing unit 43 fails to contain determination policy certificate retrieval information 300 (No in step S302), then the attribute certificate verification unit 42 determines, as described above, whether or not the values of all the items in the holder field 83 of the attribute certificate 80B are identical to the values of corresponding items in the subject field 73 of the public key certificate 70-i (step S111). If it turns out that the values of every pair of the items are identical to each other (OK in step S111), then the process goes to step S106 in which the random-number data with a signature affixed thereto are verified. If it turns out that the values of any pair of the items are not identical to each other (NG in step S111), then the attribute certificate verification unit 42 determines that a linkage between the public key certificate 70-i and the attribute certificate 80B is not confirmed, thus producing a verification result to the effect that the attribute certificate 80B is invalid, and proceeds to step S109 in which the verification result is transmitted out.

If the signature is verified successfully (OK in step S303), then the attribute certificate verification unit 42 consults the determination policy certificate retrieval information 300 (see FIG. 17) for the location 302 at which the determination policy certificate is released to public, and retrieves the determination policy certificate 90 released by the attribute authority apparatus 20B from the site designated in the location 302 of the determination policy certificate retrieval information 300 (step S304), and then proceeds to step S305. If the signature is not verified (NG in step S303), then the attribute certificate verification unit 42 produces a verification result to the effect that the attribute certificate 80B is invalid, and proceeds to step S109 in which the verification result is transmitted out.

Steps S305 and S306 proceed in the same manner as steps S203 and S205 of the detailed process for verification of the attribute certificate performed in the attribute certificate verification unit 42 according to the third embodiment shown in FIG. 16, and thus a duplicate description thereof will be omitted. Similarly, steps S103 through S111 proceed in the same manner as in the first embodiment shown in FIG. 9, and thus a duplicate description thereof will be omitted, as well.

It is to be understood that the service provider apparatus 40 may, in step S304, not necessarily obtain a determination policy certificate 90 from the location at which it is released to public by the attribute authority apparatus 20B at each time when verification is to be made as in step S304, but may rather cache the determination policy certificate 90 in a memory of the service provider apparatus 40 to verify the attribute certificate using the cached determination policy certificate 90.

Alternatively, location information on a location at which an up-to-date determination policy certificate is released to public may be recorded in the location field 95 (at which the invalidation information is released to public) in the determination policy certificate 90 as shown in FIG. 13, and the determination policy certificate 90 may be stored, in advance, in the user terminal 30-i as in the third embodiment so that the user terminal 30-i may transmit the determination policy certificate 90 when making a request for a service to the service provider apparatus 40, to allow the service provider apparatus 40 to obtain the up-to-date determination policy certificate from the location designated by the location information recorded in the determination policy certificate 90 on the location at which the up-to-date determination policy certificate 90 is released to public.

According to the present embodiment, the attribute authority apparatus 20B of the attribute authority responsible for issuance of the attribute certificate 80B is configured to record, in the holder field 83 of the attribute certificate 80B with the entityName option applied thereto, information recorded in the subject field 73 of the public key certificate 70-i of the user, and to record in the determination policy field 96 of the determination policy certificate 90, and release to public by the determination policy certificate publisher 27, one or more items to be checked by the service provider apparatus 40 for determination to be made to verify the attribute certificate 80B, i.e., the linkage with the public key certificate 70-i, and criteria for the determination. When the service provider apparatus 40 in turn verifies the linkage between the public key certificate 70-i and the attribute certificate 80B, the service provider apparatus 40 performs the steps of consulting the determination policy certificate retrieval information 300 for the location 302 at which the determination policy certificate is released to public, retrieving the determination policy certificate 80B from the site designated by the location 302 in the determination policy certificate retrieval information 300, checking the linkage between the determination policy certificate 90 and the attribute certificate 80B, and verifying the signature of the determination policy certificate 90, to thereafter obtain the determination policy 96. When the determination policy 96 is obtained, the service provider apparatus 40 obtains the determination policy 96, and determines whether or not the data in one or more items (e.g., items 961-964) designated in the determination policy 96 fulfill the criteria recorded in the determination policy 96, by comparing information recorded in the holder field 83 of the attribute certificate 80B with information recorded in the subject field 73 of the public key certificate 70-i. Accordingly, a single attribute certificate 80B associated with a plurality of public key certificates 70-i can be utilized.

According to the first and second embodiments, and any modifications thereof, of the present invention, the authenticity of the attribute certificate 80 or 80A can be confirmed with the help of the determination policy 86, and the attribute certificate 80 or 80A can thus be verified. Therefore, verification of the attribute certificate 80 or 80A can be performed in accordance with purposes of the application, such as verification of the linkage between the public key certificate 70-i and the attribute certificate 80 or 80A. In these embodiments, in contrast to the existing methods as described in JP 2004-282636 A, no modification in the format or the like of the public key certificates 70-i which have already been widely used is required. Data areas required for recording the determination policy can be reduced more in comparison with the data areas required for recording a hash value of the pre-update public key certificate in the public key and attribute certificates. Thus, the present invention can be applied easily to the existing systems which implement verification scheme based upon the public key certificate 70-i.

According to the third and fourth embodiments of the present invention, in which the determination policy is recorded in a determination policy certificate 90, in contrast to the first and second embodiments in which the attribute certificate 80 or 80A contains information for making the determination policy 86 available, the authenticity of the attribute certificate 80B can be confirmed with the help of the determination policy certificate 90, and the attribute certificate 80B can thus be verified without any modification required in the format of the attribute certificate 80B as well as the public key certificate 70-i. Therefore, verification of the attribute certificate 80B can be performed in accordance with purposes of the application, such as verification of the linkage between the public key certificate 70-i and the attribute certificate 80B. Furthermore, no re-issuance/re-distribution of the attribute certificate 80B is necessitated even when the determination policy is changed after the attribute certificate 80B is issued.

It is appreciated that one or more of the elements or functional units or method steps, any combination thereof, illustrated in the exemplary embodiments of the present invention may be embodied in software, hardware, firmware or any combination thereof and/or stored in a computer readable medium. Thus, the present invention may be embodied as a computer program product which may be stored in a storage medium and/or transferred via a communication medium, and may be implemented as a system distributed over a number of computers via a communication medium or network.

It is contemplated that numerous modifications may be made to the exemplary embodiments of the invention without departing from the spirit and scope of the embodiments of the present invention as defined in the following claims.

What is claimed is:

1. An attribute certificate verification method, for a service provider apparatus which provides a service on a network, to verify an attribute certificate of a user who uses a user terminal to receive the service, the attribute certificate verification method comprising:
allowing an attribute authority apparatus of an attribute authority responsible for issuance of an attribute certificate to record a determination policy in the attribute certificate, the determination policy comprising information designating at least one item to be checked by the service provider apparatus for determination to be made to verify the attribute certificate, and a criterion for the determination; and
allowing the service provider apparatus to verify the attribute certificate transmitted from the user terminal by:
obtaining the determination policy recorded in the attribute certificate; and
determining whether data in the at least one item designated in the determination policy fulfill the criterion recorded in the determination policy to verify the attribute certificate.

2. An attribute certificate verification method, for a service provider apparatus which provides a service on a network, to verify an attribute certificate of a user who uses a user terminal to receive the service, the attribute certificate verification method comprising:
allowing an attribute authority apparatus of an attribute authority responsible for issuance of an attribute certificate to release a determination policy to public and to record, in the attribute certificate, location information on a location at which the determination policy is released, the determination policy comprising information designating at least one item to be checked by the service provider apparatus for determination to be made to verify the attribute certificate, and a criterion for the determination; and
allowing the service provider apparatus to verify the attribute certificate transmitted from the user terminal by:
obtaining the location information recorded in the attribute certificate;
obtaining the determination policy from the location designated by the location information; and
determining whether data in the at least one item designated in the determination policy fulfill the criterion recorded in the determination policy to verify the attribute certificate.

3. An attribute certificate verification method according to claim 1 further comprising:
allowing the attribute authority apparatus to record, in a holder field of the attribute certificate with an entityName option applied thereto, information recorded in a subject field of a public key certificate of the user, wherein the information comprises the at least one item designated in the determination policy,
wherein the determining step comprises comparing information recorded in the holder field of the attribute certificate with information recorded in the subject field of the public key certificate.

4. An attribute certificate verification method according to claim 2 further comprising:
allowing the attribute authority apparatus to record, in a holder field of the attribute certificate with an entityName option applied thereto, information recorded in a subject field of a public key certificate of the user, wherein the information comprises the at least one item designated in the determination policy,
wherein the determining step comprises comparing information recorded in the holder field of the attribute certificate with information recorded in the subject field of the public key certificate.

5. An attribute authority apparatus for transmitting, to a user terminal configured to communicate through a network with a service provider apparatus, an attribute certificate issued for a user who uses the user terminal to receive a service from the service provider apparatus, the attribute authority apparatus comprising a controller,
the controller comprising:
means for recording, in a holder field of the attribute certificate with an entityName option applied thereto, information recorded in a subject field of a public key certificate of the user of the user terminal; and
means for recording a determination policy in the attribute certificate, the determination policy comprising information designating at least one item to be checked by the service provider apparatus for determination to be made to verify the attribute certificate transmitted from the user terminal, and a criterion for the determination.

6. An attribute authority apparatus for transmitting, to a user terminal configured to communicate through a network with a service provider apparatus, an attribute certificate issued for a user who uses the user terminal to receive a service from the service provider apparatus, the attribute authority apparatus comprising a controller,
the controller comprising:
means for recording, in a holder field of the attribute certificate with an entityName option applied thereto, information recorded in a subject field of a public key certificate of the user of the user terminal;
means for releasing a determination policy to public, the determination policy comprising information designating at least one item to be checked by the service provider apparatus for determination to be made to verify the attribute certificate transmitted from the user terminal, and a criterion for the determination; and
means for recording, in the attribute certificate, location information on a location at which the determination policy is released.

7. A service provider apparatus for providing a service on a network, wherein the service provider apparatus is configured to verify an attribute certificate of a user who uses a user terminal to receive the service, and comprises a controller,
the controller comprising:
means for obtaining a determination policy which comprises information designating at least one item to be checked for determination to be made to verify the attribute certificate transmitted from the user terminal, and a criterion for the determination; and
means for determining whether data in the at least one item designated in the determination policy fulfill the criterion recorded in the determination policy to verify the attribute certificate, by comparing information recorded in a holder field of the attribute certificate with information recorded in a subject field of a public key certificate of the user.

8. A service provider apparatus for providing a service on a network, wherein the service provider apparatus is configured to verify an attribute certificate of a user who uses a user terminal to receive the service, and comprises a controller,
the controller comprising:
means for obtaining location information on a location at which a determination policy is released to public, the determination policy comprising information designating at least one item to be checked for determination to be made to verify the attribute certificate transmitted from the user terminal, and a criterion for the determination;
means for obtaining the determination policy from the location designated by the location information; and
means for determining whether data in the at least one item designated in the determination policy fulfill the criterion recorded in the determination policy to verify the attribute certificate, by comparing information recorded in a holder field of the attribute certificate with information recorded in a subject field of a public key certificate of the user.

9. An attribute certificate verification system comprising:
an attribute authority apparatus according to claim 5; and
a service provider apparatus according to claim 7.

10. An attribute certificate verification system comprising:
an attribute authority apparatus according to claim 6; and
a service provider apparatus according to claim 8.

11. An attribute certificate verification method, for a service provider apparatus which provides a service on a network, to verify an attribute certificate of a user who uses a user terminal to receive the service, the attribute certificate verification method comprising:
allowing an attribute authority apparatus of an attribute authority responsible for issuance of an attribute certificate to record a determination policy in a determination policy certificate, the determination policy comprising information designating at least one item to be checked by the service provider apparatus for determination to be made to verify the attribute certificate, and a criterion for the determination;
allowing the attribute authority apparatus to release to public validation information for establishing validity of the determination policy certificate; and
allowing the service provider apparatus to verify the attribute certificate transmitted from the user terminal by:
ascertaining the validity of the determination policy certificate transmitted together with the attribute certificate, based upon the validation information; and
determining whether data in the at least one item designated in the determination policy recorded in the determination policy certificate fulfill the criterion recorded in the determination policy to verify the attribute certificate.

12. An attribute certificate verification method, for a service provider apparatus which provides a service on a network, to verify an attribute certificate of a user who uses a user terminal to receive the service, the attribute certificate verification method comprising:
allowing an attribute authority apparatus of an attribute authority responsible for issuance of an attribute certificate to release a determination policy certificate to public and to create determination policy certificate retrieval information including location information on a location at which the determination policy certificate is released, the determination policy certificate comprising information on a determination policy, the determination policy comprising information designating at least one item to be checked by the service provider apparatus for determination to be made to verify the attribute certificate, and a criterion for the determination; and
allowing the service provider apparatus to verify the attribute certificate transmitted from the user terminal by:
obtaining the location information included in the determination policy certificate retrieval information transmitted together with the attribute certificate;
obtaining the determination policy certificate from the location designated by the location information; and
determining whether data in the at least one item designated in the determination policy certificate fulfill the criterion recorded in the determination policy certificate to verify the attribute certificate.

13. An attribute certificate verification method according to claim 11 further comprising:
allowing the attribute authority apparatus to record, in a holder field of the attribute certificate with an entityName option applied thereto, information recorded in a subject field of a public key certificate of the user, wherein the information comprises the at least one item designated in the determination policy,
wherein the determining step comprises comparing information recorded in the holder field of the attribute certificate with information recorded in the subject field of the public key certificate.

14. An attribute certificate verification method according to claim 12 further comprising:
allowing the attribute authority apparatus to record, in a holder field of the attribute certificate with an entityName option applied thereto, information recorded in a subject field of a public key certificate of the user, wherein the information comprises the at least one item designated in the determination policy,
wherein the determining step comprises comparing information recorded in the holder field of the attribute certificate with information recorded in the subject field of the public key certificate.

15. An attribute authority apparatus for transmitting, to a user terminal configured to communicate through a network with a service provider apparatus, an attribute certificate issued for a user who uses the user terminal to receive a service from the service provider apparatus, the attribute authority apparatus comprising a controller,
the controller comprising:
means for recording, in a holder field of the attribute certificate with an entityName option applied thereto, information recorded in a subject field of a public key certificate of the user of the user terminal;
means for recording a determination policy in a determination policy certificate, the determination policy comprising information designating at least one item to be checked by the service provider apparatus for determination to be made to verify the attribute certificate transmitted from the user terminal, and a criterion for the determination; and
means for releasing validation information for establishing validity of the determination policy certificate.

16. An attribute authority apparatus for transmitting, to a user terminal configured to communicate through a network with a service provider apparatus, an attribute certificate issued for a user who uses the user terminal to receive a service from the service provider apparatus, the attribute authority apparatus comprising a controller,
the controller comprising:
means for recording, in a holder field of the attribute certificate with an entityName option applied thereto, information recorded in a subject field of a public key certificate of the user of the user terminal;
means for releasing a determination policy certificate to public, the determination policy comprising information designating at least one item to be checked by the service provider apparatus for determination to be made to verify the attribute certificate transmitted from the user terminal, and a criterion for the determination; and
means for creating determination policy certificate retrieval information including location information on a location at which the determination policy certificate is released.

17. A service provider apparatus for providing a service on a network, wherein the service provider apparatus is configured to verify an attribute certificate of a user who uses a user terminal to receive the service, and comprises a controller,
the controller comprising:
means for receiving a determination policy certificate in which is recorded a determination policy comprising information designating at least one item to be checked for determination to be made to verify the attribute certificate transmitted from the user terminal, and a criterion for the determination;
means for ascertaining validity of the determination policy certificate; and
means for determining whether data in the at least one item designated in the determination policy certificate fulfill the criterion recorded in the determination policy certificate to verify the attribute certificate, by comparing information recorded in a holder field of the attribute certificate with information recorded in a subject field of a public key certificate of the user.

18. A service provider apparatus for providing a service on a network, wherein the service provider apparatus is configured to verify an attribute certificate of a user who uses a user terminal to receive the service, and comprises a controller,
the controller comprising:
means for receiving the attribute certificate and a determination policy certificate retrieval information including location information on a location at which a determination policy certificate is released to public, the determination policy certificate including a determination policy which comprises information designating at least one item to be checked for determination to be made to verify the attribute certificate transmitted from the user terminal, and a criterion for the determination;
means for obtaining the determination policy certificate from the location designated by the location information included in the determination policy certificate retrieval information; and
means for determining whether data in the at least one item designated in the determination policy certificate fulfill the criterion recorded in the determination policy certificate to verify the attribute certificate, by comparing information recorded in a holder field of the attribute certificate with information recorded in a subject field of a public key certificate of the user.

19. An attribute certificate verification system comprising:
an attribute authority apparatus according to claim 15; and
a service provider apparatus according to claim 17.

20. An attribute certificate verification system comprising:
an attribute authority apparatus according to claim 16; and
a service provider apparatus according to claim 18.
